(19) United States
(12) Patent Application Publication
(10) Pub. No.: US 2012/0026534 A1
(43) Pub. Date: Feb. 2, 2012

(54) JOB PROCESSING METHOD OF IMAGE FORMING APPARATUS AND IMAGE FORMING APPARATUS

(75) Inventor: Kazuhiro URUMA, Kawasaki-shi (JP)

(73) Assignee: CANON KABUSHIKI KAISHA, Tokyo (JP)

(21) Appl. No.: 13/267,137

(22) Filed: Oct. 6, 2011

Related U.S. Application Data
(62) Division of application No. 11/171,373, filed on Jul. 1, 2005.

(30) Foreign Application Priority Data
Jul. 9, 2004 (JP) 2004203706

(51) Int. Cl. G06K 15/02

(52) U.S. Cl. 358/1.14

(57) ABSTRACT

In an image forming apparatus capable of processing data of a plurality of jobs that include at least any one of a copy function job, a sending function job and a print function job, when data of jobs currently processed and/or jobs in a waiting state for processing by the image forming apparatus are stored in a storage unit storing a plurality of data at the time an operation relating to powering off the image forming apparatus is performed by an operator, the fact that the jobs currently processed and/or the jobs in a waiting state exist is notified as information that can be confirmed by the operator.

### FIELD OF THE INVENTION

The present invention relates to an image forming apparatus and a job processing method for an image forming apparatus, and more particularly to control that is executed when shutting down the power of an image forming apparatus such as a digital. Multi Function Peripheral.

### BACKGROUND OF THE INVENTION

In recent years, decoding that incorporates various functions such as those of a copying machine and a printer that are used in offices and the like into one machine has been proceeding, and image forming apparatuses called “digital Multi Function Peripherals (MFP)” that include the functions of both a copying machine and a printer in one unit in which a printer controller having an image processing function is included within a copying machine are being sold commercially. These Multi Function Peripherals are being made even more multi-functional through the further addition of a facsimile function and the like.

Some conventional digital Multi Function Peripherals have been equipped with a sleep mode to reduce power consumption when the machine is not in use.

However, because power is consumed even in sleep mode, albeit only slightly, in some cases the user shutdowns the power of the main body. Further, due to an increase in security consciousness in recent years, end users increasingly wish to shutdown the power of the main body after use.

Therefore, some recent digital Multi Function Peripherals are equipped with a mode called “shutdown mode” that shutdowns the main power supply after the completion of all the jobs that were input.

For example, Japanese Patent Laid-Open No. 2001-265174 discloses an apparatus that, if in the process of executing an image forming operation when it accepts an execution instruction to shutdown the main power supply, displays an indication to the effect that it has accepted an execution instruction to shutdown the main power supply, and then shutdowns the main power supply after the image forming operation is completed.

However, in the apparatus according to the prior art, for example, although the apparatus may be able to display the fact that it has accepted an instruction to shutdown the power supply, even though the apparatus may be in a state at that time in which a job has been input, is being currently processed or is in a waiting state, the apparatus is not able to confirm the situation with the user. Therefore, since the user is unaware of this situation, some problems still remain with this type of configuration in terms of operability, usability, management and the like.

Further, for example, even though input jobs exist at the time of shutting down the power supply, it is also not possible to confirm by use of a display or the like what kind of input jobs exist or which jobs can be recovered and which job can be not recovered when the power is shutdown. Also, for example, although a print job (for example, a secured print job) that can not be executed until a user performs a predetermined operation including the input of a password or the like has been input as a job, a display to make the user aware of (the state of) this kind of job is not displayed.

### SUMMARY OF THE INVENTION

An object of this invention is, for example, to enable a user to easily recognize jobs that will be affected by shutdown processing that shutdowns the power supply before conducting the shutdown processing.

Another object of this invention is, for example, to also make it possible to prevent new separate problems occurring in which a user is notified of excessive information or the like for the purpose of enabling the user in question to easily recognize jobs that will be affected by shutdown processing.

A further object of this invention is, for example, to make it possible to enhance the operating rate and productivity of the apparatus as much as possible while also fulfilling the above objects.

A still further object of this invention is, for example, to enable the provision of a flexible apparatus and system that meets the various needs of users while taking into account the utilization environment of the apparatus and also fulfilling the above-described objects.

According to one aspect of the present invention, the above object is attained by a job processing method adapted to an image forming apparatus that is capable of processing data of a plurality of jobs including at least one job from the group consisting of: a job of a copy function that prints data from a scanner unit by a printer unit using a storage unit capable of storing a plurality of data, a job of a sending function that sends data of the storage unit to another apparatus, and a job of a print function that prints data from another apparatus by the printer unit using the storage unit, comprising: causing a notification unit to notify an information concerning the image forming apparatus; and enabling notification to an operator through notification unit of information that enables the operator to confirm the fact that there is a job currently processed by the image forming apparatus and/or information that enables the operator to confirm the fact that there is a job in a waiting state for processing by the image forming apparatus, in a case where an operation relating to powering off the image forming apparatus is performed by the operator, when data of a job currently processed by the image forming apparatus and/or data of a job in a waiting state for processing by the image forming apparatus are stored in the storage unit.

Accordingly, it is possible for a user to easily recognize the presence or absence of a job that will be affected by shutting down the power supply as well as the job information thereof before the power supply is shutdown.

In a case where an operation relating to powering off the image forming apparatus is performed by the operator, when data of a job currently processed by the image forming apparatus and/or data of a job in a waiting state for processing by the image forming apparatus are stored in the storage unit, it is possible to notify an operator through the notification unit of information that enables the operator to confirm the fact that there is a job currently processed by the image forming apparatus and/or information that enables the operator to confirm the fact that there is a job in a waiting state for processing by the image forming apparatus, whereas information relating to jobs for which data is not erased from the storage unit even when the power of the image forming apparatus is turned off may not be notified by the notification unit.

In a case where an operation relating to powering off the image forming apparatus is performed by the operator, when a job for which data is erased from the storage unit when the power is shutdown is currently processed and/or in a waiting state for processing by the image forming apparatus, it may be possible to notify an information of the job to the operator through the notification unit.

In a case where an operation relating to powering off the image forming apparatus is performed by the operator, when a job for which data is erased from the storage unit when the power is shutdown is currently processed and/or in a waiting state for processing by the image forming apparatus, it is possible to notify an information of the job to the operator through the notification unit, whereas if data to be held after powering off is stored in the storage unit, information relating to a job to which that data belongs may not be notified through the notification unit.

In a case where an operation relating to powering off the image forming apparatus is performed by the operator, when a job for which processing cannot be executed once again by the image forming apparatus after the power of the image forming apparatus is turned on again is currently processed and/or in a waiting state for processing by the image forming apparatus, it may be possible to notify an information of the job to the operator through the notification unit.

In a case where an operation relating to powering off the image forming apparatus is performed by an operator, when a job for which processing cannot be executed once again by the image forming apparatus after the power of the image forming apparatus is turned on again is currently processed or in a waiting state for processing by the image forming apparatus, it is possible to notify an operator through the notification unit of an information of the job, whereas the information of the job for which processing can be executed once again by the image forming apparatus after the power of the image forming apparatus is turned on again may not be notified through the notification unit.

A digital Multi Function Peripheral that includes a plurality of functions consisting of a copy function, a print function and a facsimile function is suitable as an image forming apparatus that applies this invention.

According to another aspect of the present invention, the above object is attained by an image forming apparatus comprising: a processor adapted to enable the processing of data of a plurality of jobs including at least one job from the group consisting of: a job of a copy function that prints data from a scanner unit with a printer unit using a storage unit capable of storing a plurality of data, a job of a sending function that sends data of the storage unit to another apparatus, and a job of a print function that prints data from another apparatus with the printer unit using the storage unit; and a controller adapted to enable notification to the operator through a notification unit of information that enables the operator to confirm the fact that there is a job currently processed by the image forming apparatus and/or information that enables the operator to confirm the fact that there is a job in a waiting state for processing by the image forming apparatus, in a case where an operation related to powering off the image forming apparatus was performed by an operator, when data of a job currently processed by the image forming apparatus and/or data of a job in a waiting state for processing by the image forming apparatus is stored in the storage unit.

Further, the foregoing objects are also achieved by an image forming system that executes the aforementioned job processing method, a program that executes the method, and a storage medium that stores the program.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a configuration example of a network system that includes the image processing apparatus of this invention;

FIG. 2 is a block diagram showing a configuration example of a digital Multi Function Peripheral as an embodiment of the image processing apparatus of this invention;

FIG. 3 is a view showing the external appearance of the console display of FIG. 2;

FIG. 4 is a view showing the standard copy screen that is displayed on the liquid crystal display part;

FIG. 5 is a view showing a special features screen that is displayed on the liquid crystal display part;

FIG. 6 is a view showing a sending screen that is displayed on the liquid crystal display part;

FIG. 7 is a view showing a sending screen that is displayed on the liquid crystal display part;

FIG. 8 is a view showing a mail box selection screen that is displayed on the liquid crystal display part;

FIG. 9 is a view showing a document selection screen that is displayed on the liquid crystal display part;

FIG. 10 is a view showing a first shutdown confirmation screen of an embodiment of this invention;

FIG. 11 is a view showing a second shutdown confirmation screen of an embodiment of this invention;

FIG. 12 is a view showing a shutdown performing screen of an embodiment of this invention;

FIG. 13 is a flowchart that illustrates the display processing of the first shutdown confirmation screen;

FIG. 14 is a flowchart that illustrates the display processing of the second shutdown confirmation screen;

FIG. 15 is a view showing one example of an administration table for jobs that are objects of printing;

FIG. 16 is a view showing a common setting screen; and

FIG. 17 is a view showing a setting screen for shutdown mode.

### DETAILED DESCRIPTION OF THE PREFERRED EMBODIMENTS

Preferred embodiments of the present invention will now be described in detail in accordance with the accompanying drawings. Note that each elements in the following embodiments is not intended to limit the scope of the invention, but is described only as an example.

### <System Configuration>

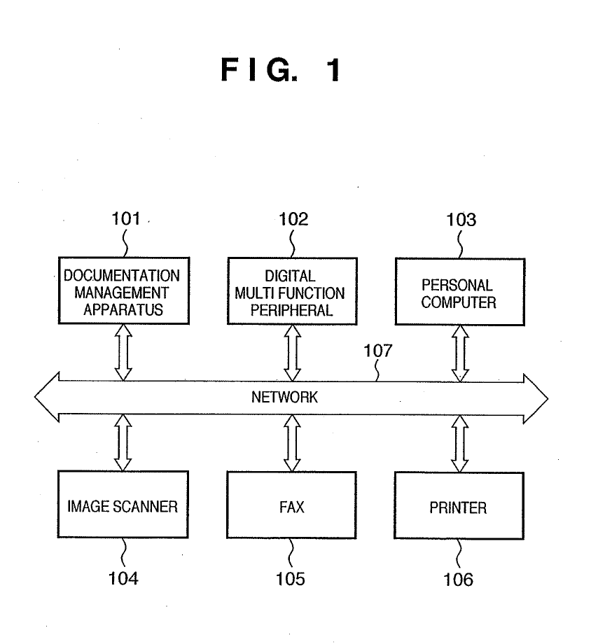

FIG. 1 is a block diagram showing a configuration example of a network system (also referred to as an image processing system, an image forming system, or simply a printing system) that includes the image processing apparatus of this invention.

As shown in the figure, a documentation management apparatus 101, a digital Multi Function Peripheral (MFP) 102 as an embodiment of the image processing apparatus of this invention that has scanner and printer functions, a personal computer 103, an image scanner 104, a facsimile apparatus 105 and a printer 106 are connected to each other by network means 107.

In this specification, the digital Multi Function Peripheral 102, the image scanner 104, the facsimile 105, the printer 106 and the like are referred to collectively as “image processing apparatus.” The network means 107 is implemented utilizing wired or wireless communication means such as a wireless LAN, a wired LAN or a public circuit.

### <Configuration of Digital Multi Function Peripheral>

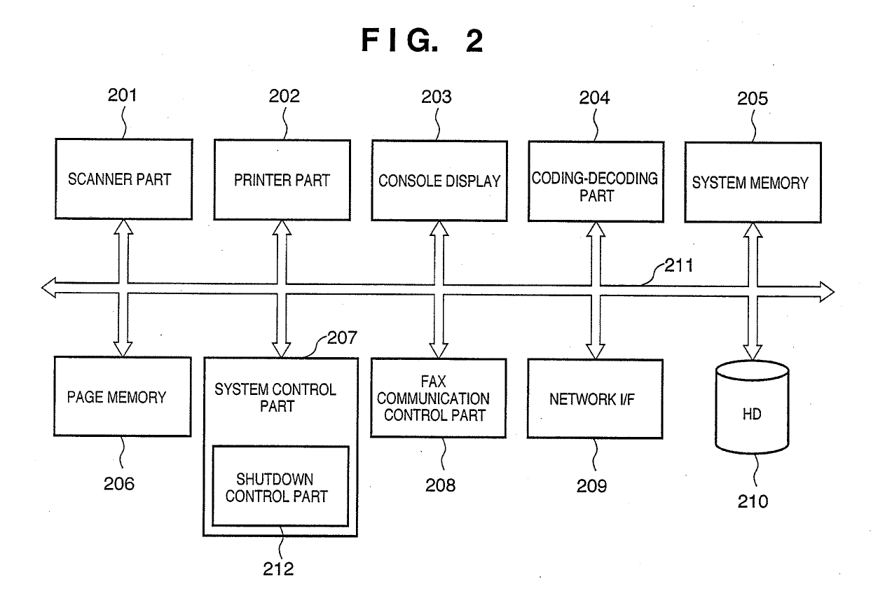

FIG. 2 is a block diagram showing a configuration example of a digital Multi Function Peripheral 102 as an embodiment of the image processing apparatus (also referred to as “image forming apparatus” or simply as “printing apparatus”) of this invention.

The digital Multi Function Peripheral 102 of this embodiment comprises a scanner part 201, a printer part 202, a console display 203, a coding-decoding part 204, a system memory 205, a page memory 206, a system control part 207 including a shutdown control part 212, a FAX communication control part 208, a network I/F 209, a hard disk (HD) 210 and an internal bus 211 that connects each part.

The scanner part 201 creates image data by reading an original in accordance with a specified mode (for example, paper size, resolution, density etc.), and the printer part 202 prints a document (image) that has been specified for printing and outputs the document (image) to a delivery tray through a delivery apparatus such as a finisher. The console display 203 allows a user to carry out various setting operations and also displays the operating state of the apparatus and the like. The coding-decoding part 204 encodes and compresses image data for sending, and also decodes compressed data that was received and restores it to the original image data.

The system memory 205 comprises a RAM part and a ROM part, and stores information that was previously registered in the apparatus. In the page memory 206, image data of the amount of one page is expanded when conducting encoding and decoding. The system control part 207 comprises a micro computer that includes a central processing unit (CPU) that monitors and controls each part shown in the block diagram or the overall apparatus. Inside this system control part 207 is included the shutdown control part 212 that performs shutdown processing that is described in detail below.

The communication control part 208 is connected to a facsimile line such as a PSTN line and communicates with other facsimile apparatuses through the PSTN line. The network I/F 209 is connected to a network such as a LAN and communicates with other devices connected to the network. The HD (hard disk) 210 is a nonvolatile large capacity memory such as a magnetic disk that is capable of storing data of a plurality of jobs, on which received document data or scanned document data or the like can be stored in, for example, file format.

The digital Multi Function Peripheral 102 of this embodiment uses the HD 210 with a large-capacity memory as one example of a data storage unit, and is configured to be capable of processing a plurality of job data (also referred to simply as “jobs”) of various kinds sequentially and concurrently (simultaneously).

For example, the digital Multi Function Peripheral 102 of this embodiment contains a copy function (also referred to as “copy mode”) that causes job data (a series of print image data comprising one page or a plurality of pages) that was input from the scanner part 201 thereof as a printing object to be printed by the printer part 202 thereof through the HD 210.

Further, the digital Multi Function Peripheral 102 is also equipped with a print function (also referred to as “print mode”) that receives data from another apparatus (for example, an information processing apparatus such as the image scanner apparatus 104, the documentation management apparatus 101 or the personal computer 103, or an external apparatus such as the facsimile apparatus 105 or another digital Multi Function Peripheral that has an equivalent configuration and functions as the digital Multi Function Peripheral 102) through a data communication unit for performing processing to send and receive data (for example, a communications interface unit such as the network I/F part 209 or the FAX communication control part 208), and prints the job data that was accepted from the other apparatus as a printing object with the printer part 202 thereof through the HD 210.

The digital Multi Function Peripheral 102 is also equipped with a send/facsimile function (also referred to as “send/facsimile mode”) that subjects job data accepted from the scanner part 201 thereof and/or job data accepted from another apparatus (for example, an information processing apparatus such as the image scanner apparatus 104, the documentation management apparatus 101 or the personal computer 103, or an external apparatus such as the facsimile apparatus 105) to data sending processing with respect to another apparatus (for example, an information processing apparatus such as the image scanner apparatus 104, the documentation management apparatus 101 or the personal computer 103, or an external apparatus such as the facsimile apparatus 105) by means of the aforementioned data communication unit (for example, a communications interface unit such as the network I/F part 209 or the FAX communication control part 208) through the HD 210.

In addition, the digital Multi Function Peripheral 102 is also equipped with a mail box function that stores data accepted from the scanner part 201 of the apparatus and/or job data accepted from another apparatus (for example, an information processing apparatus such as the image scanner apparatus 104, the documentation management apparatus 101 or the personal computer 103, or an external apparatus such as the facsimile apparatus 105) in a predetermined storage area called a “mail box area” inside the HD 210, and thereafter, through the console 203 of the digital Multi Function Peripheral 102, makes it possible for the user to select the desired job data from among a plurality of job data stored in the mail box area and print the selected job data using the printer part 202 according to the user's desired output processing conditions, or send the data to another apparatus by use of the aforementioned data communication unit.

Further, the digital Multi Function Peripheral 102 is capable of storing a plurality of jobs on the HD 210 and, for example, even while reading a certain job from the HD 210 and printing it with the printer part 202 or while sending the job to another apparatus by use of the aforementioned data communication unit, storing the data of another job that was input after the job in question on the HD 210 at any time, concurrently with the above type of output processing (printing processing or sending processing). Thus; the digital Multi Function Peripheral 102 makes it possible to execute input processing of a job to the HD 210 and output processing of a job from the HD 210 concurrently.

Furthermore, for example, when, in the process of reading the data of a particular job that is a printing object (for example, job A comprising 10 pages) from the HD 210 and printing the data with the printer part 202, the digital Multi Function Peripheral 102 accepts data of a separate job as a printing object (for example, job B comprising 20 pages) that is different to job A (when job B was input from an input route consisting of any one of the scanner part 201, the FAX communication control part 208 and the network I/F part 209), the data of job B that was input after job A is held on the HD 210 as a job in a waiting state for printing, and control is performed that holds the printing processing for job B on standby until the printing processing of job A has been entirely (all 10 pages) completed. Upon completion of all of the printing for job A, control is carried out to read the data of job B from the HD 210 and start printing processing for job B at the printer part 202. Thus, it is possible to store a job as a printing object in the HD 210 whenever necessary and, when a plurality of jobs as printing objects are present on the HD 210, control can be performed that prints these plurality of jobs in sequence by putting the subsequent job in a waiting state for printing until printing of the preceding job is completed, and commencing printing of the subsequent job when the printing of the preceding job has finished.

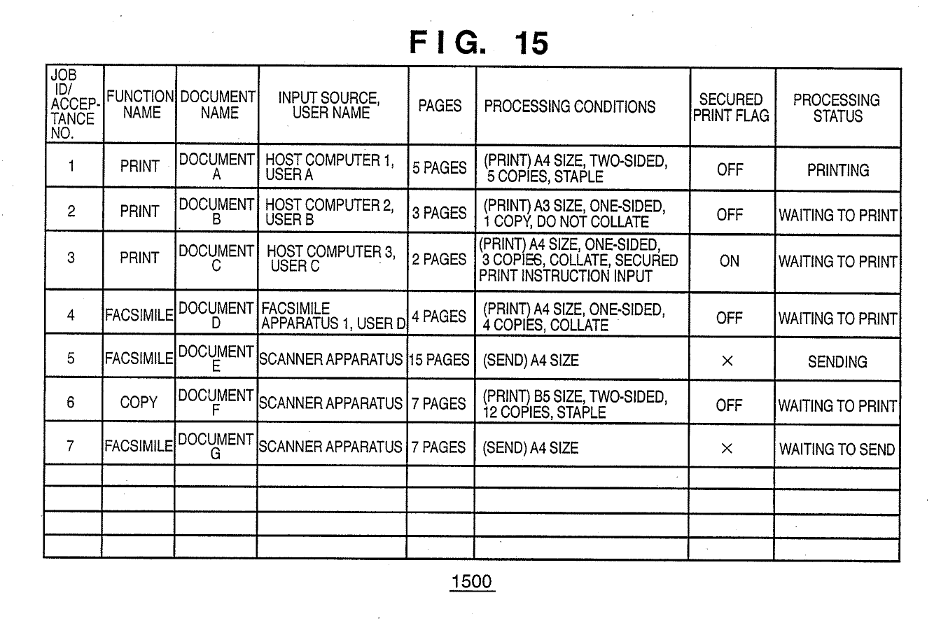

In this embodiment, the various kinds of job processing described in the foregoing are controlled by the system control part 207. In order to control the above types of printing processing for a job that is a printing object or to control sending processing for a job as an object for sending to another apparatus from the digital Multi Function Peripheral 102 by use of the send/facsimile function or the like, the control part 207 carries out control to create an administration table 1500 for controlling and managing the operations and processing of the jobs to be processed, as shown in FIG. 15, on a suitable memory, such as the HD 210, and manage the administration table 1500 on the memory.

For example, the control part 207 performs control to write the job information of printing object jobs for which data was stored in the HD 201, a print request was made, and which are in a printable state (for example, for PDL data, expanded to bit map data and in a state that can be printed on a recording paper), in the administration table 1500 as required in the order in which the jobs were accepted. The example of FIG. 15 illustrates a case in which five jobs for printing, i.e. documents A, B, C, D and F, are entered in the administration table 1500.

Furthermore, the control part 207 performs control, by use of the send/facsimile function, to write the job information of jobs that are objects for sending for which data was stored in the HD 201, a send request was made, and that are in a state in which the data can be sent, in the administration table 1500 as required in the order in which the jobs were accepted. The example of FIG. 15 illustrates a case in which two jobs for sending, i.e. documents E and G, are entered in the administration table 1500.

The control part 207 performs control to assign an acceptance number to each job in the administration table 1500 and to write, for each job, information for identifying (specifying) the function name, information for identifying the input source and user name, information for identifying the number of pages, information for identifying the various processing conditions such as the printing conditions or sending conditions, the job processing state (various kinds of job status information including, for a printing job, information such as whether the job is currently being printed or is waiting to be printed, and for a sending job, information such as whether the job is currently being sent or is waiting to be sent) and the like in the administration table 1500.

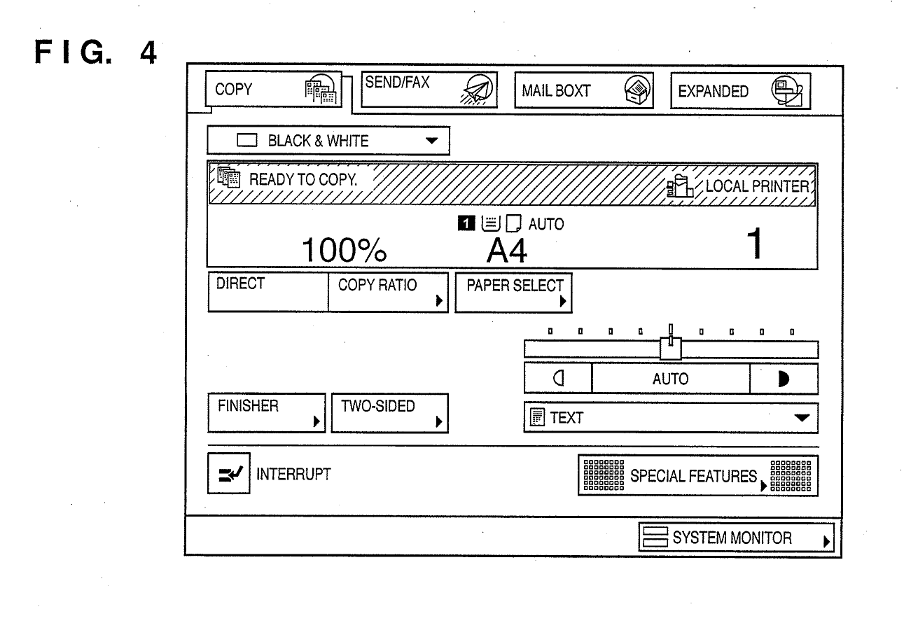

In this connection, when writing the various kinds of job information in the administration table 1500, for the information relating to function name or information relating to input source in the administration table 1500, the control part 207 uses the result of a decision it made regarding from which route of a plurality of input routes (scanner apparatus, FAX communication control part 208, and network I/F 209) the job in question was input or uses a result that was determined on the basis of information from the console 203 regarding which function button of a plurality of function buttons (for example, a copy button, a send/facsimile function button or a mail box function button on the upper part of the screen in FIG. 4) on the console 203 the user operated and the like. Further, information regarding the acceptance number and the like is allocated each time a job is entered in the table. As information concerning document name, user name, number of pages, processing conditions and the like, the results of analyzing the contents of job data that includes image data, and information regarding processing conditions set by the user at the console 203 that is acquired from the console 203 are used. Information relating to the job processing state is updated as appropriate based on the operating state and status conditions and the like of the respective devices that is acquired from the scanner part 201, the printer part 202, the FAX communication control part 208 or the network I/F 209.

Further, in the example of the administration table 1500 in FIG. 15, processing to send the job of document E to an external apparatus is executed by the FAX communication control part 208 while executing the printing processing of the job of document A at the printer part 202. Thus, in this embodiment, control is carried out by the control part 207 using the HD 210 so that an operation to print a particular job at the printer part 202 and an operation to send a different job to an external apparatus through the FAX communication control part 208 or the network I/F part 209 can be executed concurrently (simultaneously).

In this embodiment, although an example is described of processing jobs of various functions using a single administration table 1500, for example, separate tables may be established for each function or an administration table for printing jobs and an administration table for sending jobs may be separately established to carry out administration of jobs. Further, a configuration may be employed that administers jobs that are objects for processing using an administration method other than an administration method that employs a table format.

Furthermore, according to this embodiment the digital Multi Function Peripheral 102 is equipped with a secured print function that permits printing to be executed upon the user inputting authentication data (a password or the like) corresponding to the job that is the printing object through the console 203 at the time of printing a job stored in the HD 210 with the printer part 202. When authentication data was input that is different to the authentication data that corresponds to the job that is the printing object (the passwords don't match) or when the authentication data itself is not input, the secured print function inhibits reading of the job that is the printing object from the HD 210 and printing thereof by the printer part 202, and holds the job in question in a locked state on the HD 210.

When utilizing the secured print function, for example, a configuration is employed whereby, when a user sets various printing conditions on a printer driver in an external apparatus such as a host computer, the user is allowed to personally input an instruction to implement secured printing for the job that is the printing object as well as authentication data such as a password that is required when printing that job. Thereafter the user can send the job to the digital Multi Function Peripheral 102, and the control part 207, upon receiving the job in question and analyzing the job, can determine that the job is a secured print job.

In this connection, a mail box function job or the like can also be made the object of a secured print job. For example, in this embodiment, a configuration is employed in which 100 mail boxes are provided on the HD 210 and a password or the like can be set for each mail box. The configuration is such that when a user selected the mail box function and selected any mail box among a plurality of mail boxes using the console 203, if a password has been set for the selected mail box the user is requested to input a password through the console 203. When the appropriate password is input a list of the documents inside that mail box is displayed to allow the user to select the desired document from among the listed documents. When a print instruction is input from the console 203 following this series of operations, the control part may determine that the job that is read from within the mail box is a secured print job.

In this embodiment, both of the above-described two examples may be treated as secured print jobs or only one of the above-described two examples may be treated as a secured print job, or a job other than these may be treated as a secured print job.

With respect to a job that was set as a secured print job at an external apparatus such as a host computer, after the digital Multi Function Peripheral 102 receives the job, control is conducted that does not allow the job to be printed by the printer part 202 as long as authentication processing (for example, a user is requested to input authentication data at the console 203, whereupon the user inputs authentication data and processing is performed to compare the input authentication data and the authentication data that is set for the job) for the job is not executed at the Multi Function Peripheral 102, and when a fixed period has passed (for example, after one hour or one day has passed from the time of receiving the job) or when the main power supply of the digital Multi Function Peripheral 102 is shutdown by a user control is carried out to erase the job from the HD 201. Naturally, the job is also erased in a case where the user explicitly enters an erase instruction for the job from the console 203 or the user's own computer.

In contrast, since a job of a mail box function is stored and retained in the mail box area on the HD 201 even if the main power supply of the digital Multi Function Peripheral 102 is shutdown, fundamentally the configuration is such that a mail box function job is held on the HD 201 without being erased as long as the user does not explicitly input an erase instruction.

According to this embodiment, as described in the foregoing, even in a case where a user does not explicitly input an erase instruction, a job that was set as a secured print job at an external apparatus such as a host computer is treated as a secured print job for which data may be erased from the HD 210.

However, in any case, according to this embodiment the digital Multi Function Peripheral 102 is configured so that a job that requires authentication processing to allow the execution of printing to start when executing printing can be treated as a secured print job, and a job that allows printing without requiring any particular authentication processing when executing printing can be treated as a non-secured print job (also called a “normal job”).

In order to enable the control part 207 to specifically distinguish whether a job that is a printing object in the administration table 1500 is a secured print job or is not a secured print job (a normal job) for use as information to be utilized for the shutdown control that is described later herein, the administration table 1500 is configured to set a secured print flag for each job such that the flag is set to ON if the job is a secured print job and set to OFF if it is not. The control part can determine whether or not a job is a secured print job, for example, by analyzing the information of the job when the job data is received, such as determining whether a secured print execution instruction is included in the corresponding print processing conditions that are output together with image data from an external apparatus such as a computer.

By confirming this type of information in the administration table 1500, the control part 207 can execute various controls relating to shutdown processing that are described later.

In this embodiment although a description was made taking as an example of an image processing apparatus (also referred to as an image forming apparatus or a printing apparatus) a multi-functional type of apparatus (a so-called MFP: Multi Function Peripheral) equipped with a plurality of functions such as a copy function, facsimile function, print function and mail box function, this embodiment is not limited thereto, and the image processing apparatus may be a single function type of image processing apparatus (a so-called SFP: single function peripheral) that is equipped with only one function among the plurality of functions described in the foregoing. Further, although this embodiment has been described taking the case of a so-called integrated type apparatus in which the various units such as the scanner part 201, the printer part 202 and the HD 210 are provided inside the same main unit, a configuration may be adopted in which all of the individual units or one part thereof comprise a separate unit or comprise a separate constitution. Thus, various apparatuses and functional configurations can be considered, and the invention may be of any configuration as long as it does not deviate from the purport of this invention.

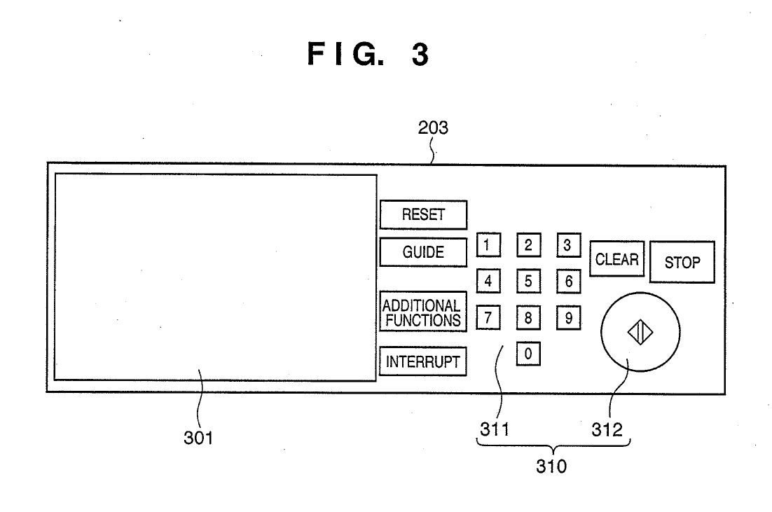

Next, the console display 203 of the digital Multi Function Peripheral 102 of this embodiment will be described. FIG. 3 is a view showing the external appearance of the console display 203. As shown in the figure, the console display 203 has a touch panel type liquid crystal display part 301 that functions both as a display to show the state of the apparatus and user messages and also as input means for the user, and operating switches 310 including ten keys 311, a start switch 312 and the like. The console display 203 is controlled by the control part 207, and the control part 207 selectively displays a plurality of operation screens on the liquid crystal display part 301 and also controls which screen is displayed and the like.

### <Display Screen>

Hereunder, a description is given of examples of screens that are displayed on the liquid crystal display part 301 under the control of the control part 207 for the basic operation of the digital Multi Function Peripheral 102 of this embodiment. In this connection, the display contents of each screen described hereunder or functions that can be set or implemented from the respective screens can be suitably changed in accordance with the specifications of the apparatus.

FIG. 4 is a view showing an initial screen that is displayed initially on the display part 301 when the digital Multi Function Peripheral 102 is activated (when the power is turned on). The standard copy screen for a state in which the copy function was selected is displayed on this initial screen. However, the user can previously specify and select the first function to be displayed after start-up from among a plurality of functions (for example, copy function, send/facsimile function, mail box function, etc.) on an initial function selection screen (not shown in the figure) that is displayed on the display part 301 by use of an additional functions key on the console 310 of FIG. 3, to thereby change the settings so that the initial screen at start-up is the screen of the selected function.

On the screen shown in FIG. 4, the user can execute the copy mode. Inside the display window, the initial settings screen (magnification ratio 100%, A4 size paper, number of copies: 1) of the copy function is displayed. The screen contains a “direct” and a “copy ratio” button that set the magnification ratio, a “paper select” button that sets the paper to be used, a “finisher” button that sets whether or not to use a finisher, a “two-sided” button that makes the setting for two-sided copying, a “special features” button for inputting an instruction that changes the display to an operation screen that allows the user to set various printing condition parameters for the copy function using various additional functions, as well as buttons for adjusting the density and the like. All of these buttons are soft keys that are displayed on the screen, and the configuration is such that various instructions are accepted in response to the part of the screen in which a′ button is displayed being touched by the user. Control is carried out so that copy processing can be executed in accordance with the printing condition settings based on instructions from a user using these buttons.

On the upper part of this screen are four function buttons that represent the “copy”, “send/facsimile”, “mail box” and “expanded” functions. The display of the buttons is controlled so that the user can distinguish which of these functions is in a selected state, by for example, displaying the currently available function (the function selected by the user) with a high level of brightness or the like. When the user presses one of the other buttons, the corresponding function becomes available. On the lower part of the screen an “interrupt” button that sets interruption processing to suspend the job currently executed and execute a new job, and a “system monitor” button used to change, confirm or cancel a job or to display a job's log and the like are provided. This “system monitor” button is configured to be displayed on all of the screens.

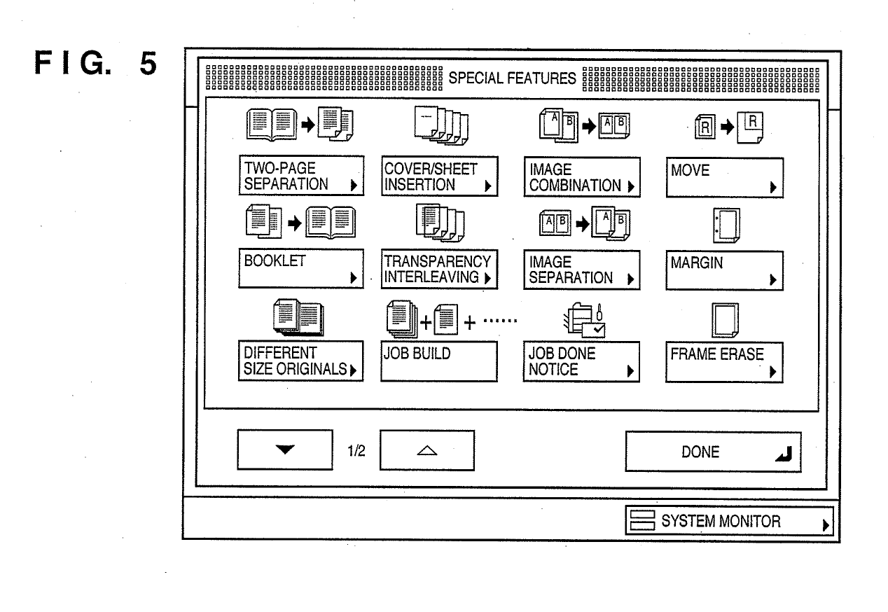

FIG. 5 is a view showing the special features screen that is displayed on the display part 301 when the “special features” button of the screen in FIG. 4 was pressed by the user. The special features screen is divided into two screens, and the first screen (½) is shown here. The configuration is such that the display switches between the two screens when the user operates the “Π” and “→” buttons on the lower left part of the figure.

The screen shown in the figure displays the respective buttons for “two-page separation”, “cover/sheet insertion”, “image combination”, “move”, “booklet”, “transparency interleaving”, “image separation”, “margin”, “different size originals”, “job build”, “job done notice” and “frame erase.” When any of these buttons is pressed by a user, control is carried out to display a details screen for setting the processing conditions of the selected function on the display part 301. When the “done” button on the lower right of the screen is pressed, the display is returned to the standard copy screen of FIG. 4.

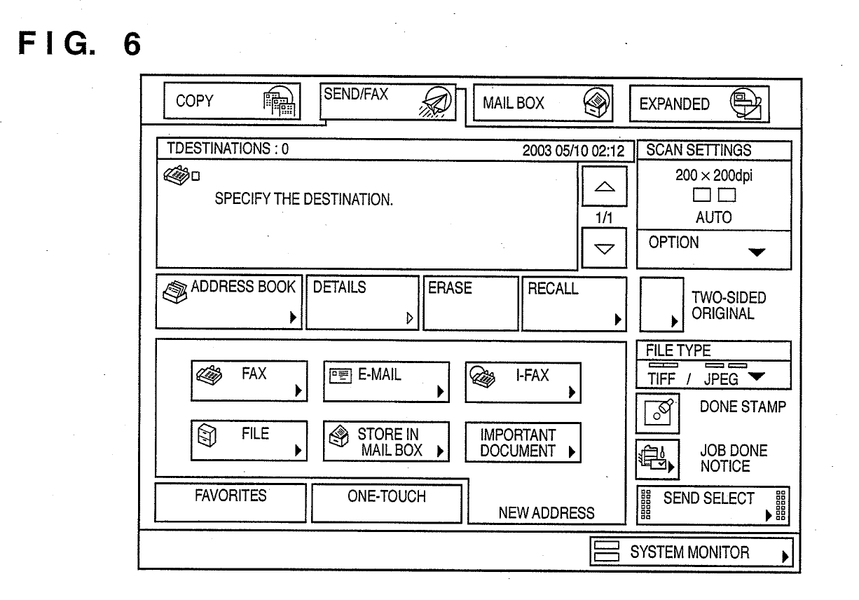

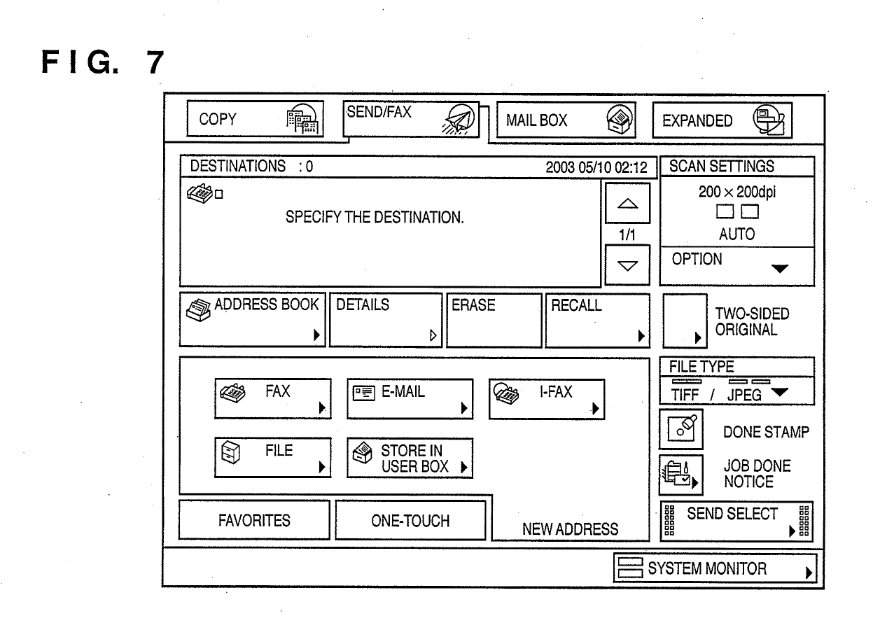

FIG. 6 and FIG. 7 are views that show a sending screen that is displayed on the display part 301 when the “send/facsimile” button for selecting the send/facsimile function was pressed by a user from among the plurality of function selection buttons provided at the top part of the screen of FIG. 4. The screen of FIG. 6 is the same as the screen of FIG. 7, except that the screen of FIG. 6 contains an “important document” button that performs settings when sending an important document.

On the sending screen, a display window that displays a destination (sending destination) specified by the user is provided in the upper part of the display area, and on the right side of the display area is provided a window that displays the detailed settings, an “option” button to allow the user to make optional settings, a button to specify a two-sided original, a “file type” button to allow the user to set the file format, a “done stamp” button to enable the user to select whether or not to print a stamp on the original that shows that sending was completed, a “job done notice” button to enable the user to select whether or not to specify that the apparatus notifies the user that a sending job has been completed and a “send settings” button for setting the sending options.

Below the window showing the destination are provided an “address book” button that displays destinations that were previously input, an “option” button for performing detailed settings for the destination, an “erase” button that erases a destination and a “recall” button that recalls a destination. Underneath these buttons are provided “fax”, “e-mail”, “I-fax”, “file” and “store in user box” buttons that allow a user to select a method from among these methods for sending or storing image data read by the scanner part with respect to a new destination. When sending to a destination that has already been registered, by pressing the “one-touch” button the user can display the destinations that have been registered, and when sending to a registered destination by a predetermined method the user can press the “standard operation” button to implement control to display the setting details of a sending method or the like that corresponds to the registered destination.

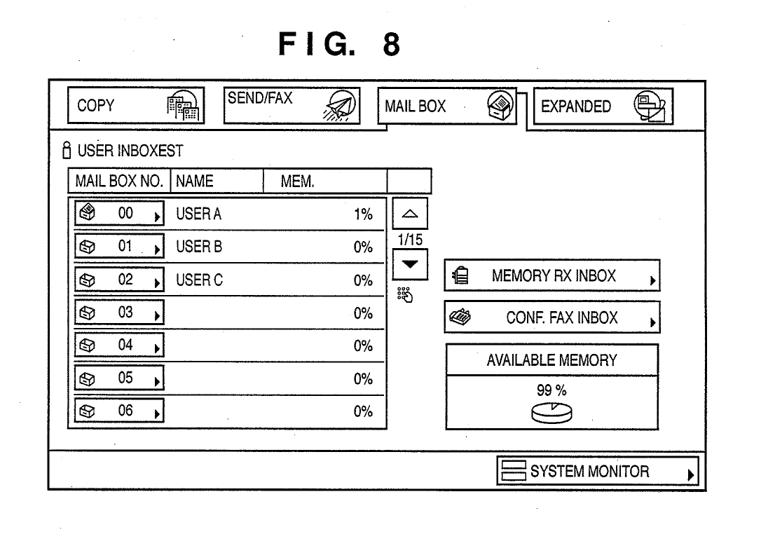

FIG. 8 is a view that shows a mail box selection screen that is displayed on the display part 301 when the “mail box” button for selecting the mail box function was pressed by a user from among the plurality of function selection buttons provided at the top part of the screen of FIG. 4. As described in the foregoing, the mail box function is a function that stores image data that was read by the scanner part or data (documents) received through a network in a storage unit such as the HD 201. The configuration in this example is one in which the mail box number, name, and memory usage amount are shown for the contents of the users' mail boxes. On the right side of the screen are provided a “memory received (RX) inbox” and a “Confirmation Fax inbox” buttons, and the configuration is such that the contents of a mail box is displayed in accordance with the button that was pressed by the user. The screen is also configured to display the remaining amount of usable memory on the bottom right thereof.

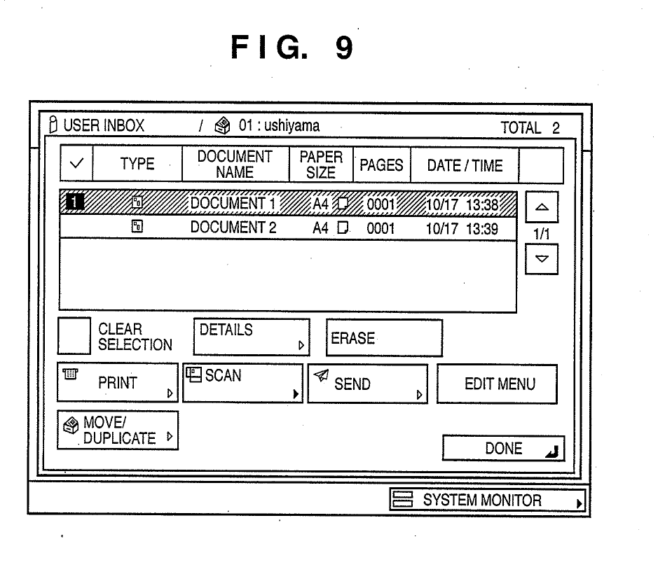

FIG. 9 is a view showing a mail box document selection screen that is displayed on the display part 301 in response to an operation by the user to select a desired mail box on the mail box selection screen of FIG. 8. The mail box document selection screen is a screen that allows the user to select a desired document from among the documents stored in the mail box that was selected on the preceding mail box selection screen or to newly register a document in the selected mail box.

FIG. 9 shows an example in which the mail box of ushiyama with the mail box number 01 was selected, and a document called “document 1” inside this mail box has been selected by the user. The area below the window of this screen is configured to display a “details” button to enable the user to input an instruction to display detailed information (information of various parameters such as the original size or printing conditions) of the document (job) that was selected on the screen on the display part 301, an “erase” button to enable the user to input an instruction to erase the document (job) that was selected on the screen from the HD 201, a “print” button to enable the user to input an instruction to print the document (job) that was selected on the screen using the printer part 202, a “scan” button to enable the user to input an instruction to register a new scan original (job) in the mail box in question, a “send” button to enable the user to input an instruction to send the document (job) that was selected on the screen to a desired sending destination, and a “move/duplicate” button that moves a document between mail boxes or duplicates a document and the like.

The screen is also configured to display an “edit menu” button to enable the user to input an instruction to edit or confirm (for example, display a preview of the document that is selected on the display part 301) the selected document (job).

The control part 207 performs overall control to enable the display of various display keys on the display part 301 and to cause the respective units to execute operations corresponding to the instructions of the buttons that were pressed by the user.

In this connection, when a mail box was selected by the user from among the plurality of mail boxes on the mail box screen of FIG. 8 and the selected mail box is a mail box for which authentication data (for example, a password) was set, the control part 207 displays on the display part 301 an authentication data input screen (not shown in the figure) to cause the user to input authentication data that was previously associated with the mail box to restrict various operations (the printing, deleting, editing or sending of a job in the mail box, or registration of a new job to that mail box) relating to that mail box. Then, on the condition that the appropriate authentication data (a password corresponding to the mail box selected in FIG. 8 or the like) was input on that screen, control is conducted to display a document selection screen for that mail box on the display part 301, as shown in FIG. 9, to allow various operations to be performed for the mail box.

By performing operations in accordance with the screen displays described in the foregoing, processing for copying, facsimile, printing, scanning, storing (mail box) and the like can be executed the using various functions of the digital Multi Function Peripheral 102.

<Turning the Power on/Off>

The digital Multi Function Peripheral 102 of this embodiment is equipped with two kinds of power switches (in this embodiment, both of these keys are mechanically hard keys, however they may also be soft switches), namely, a main power switch (not shown in the figures) that is provided on the apparatus main body (for example, on the side of the apparatus) and a console power switch (not shown in the figures) that is provided on the display console.

The console power switch is a switch for switching the state of the digital Multi Function Peripheral 102 from a normal state (for example, a state in which an operation screen is displayed on the console 203 or a state in which input/output processing of a job can be performed in real time) to the state of a sleep mode for inhibiting power consumption (for example, a sleep state corresponds to a state in which the operation screen of the console 203 is not displayed, and/or a state in which only a part of the units among the plurality of units that are in an energized state during normal operation are left in an energized state (for example, the power supply to the FAX communication control part 208, the network I/F part 209 and the HD 210 is maintained so that job data from an external apparatus can be received and accumulated on the HD 210), and the power supply to the remaining units is shutdown).

In this connection, the control part 207 performs control so that, for example, the digital Multi Function Peripheral 102 can be restored from a sleep state to a normal state in response to the receipt of a job from an external apparatus or in response to the detection of any kind of operation performed on the console 203 even without the user pressing the aforementioned console power switch again.

In contrast, the main power switch is a switch for putting the digital Multi Function Peripheral 102 in a state in which the power supply thereto is completely shutdown (for example, a state in which the power supply of each unit of the digital Multi Function Peripheral 102 is completely cut off and even processing to receive a job from an external apparatus cannot be performed; i.e., a state corresponding to the state in which the cord of the digital Multi Function Peripheral 102 has been removed from the electric outlet).

More specifically, the configuration is such that when the power of the Multi Function Peripheral 102 has been turned off by use of the main power switch, the digital Multi Function Peripheral 102 does not return to a normal state as long as the user does not press the main power switch again.

In this connection, the main power switch is turned on to start up the digital Multi Function Peripheral 102. By contrast, the configuration is such that when completely shutting down the power of the digital Multi Function Peripheral 102, the user first shifts the state of the apparatus to the shutdown mode to execute shutdown processing, and then turns the main power switch off.

In this embodiment, the term “shutdown processing” includes, for example, processing that erases from the HD 210 data such as a job currently undergoing print processing or a job in a waiting state for print processing as a job to be printed by the digital Multi Function Peripheral 102, or a job in a waiting state for sending processing as a job to be sent to an external apparatus (for example, the data of jobs entered in the administration table 1500 of FIG. 15) and the like from among a plurality of data of various kinds stored in a memory such as the HD 210. Thus, shutdown processing includes processing to erase the data of a job that is an object for processing by the Multi Function Peripheral 102.

The erase processing may be of various forms such as a method that completely erases the actual data by overwriting with other data the actual data itself of the data that is the erasing object or a method that makes it no longer possible to read the actual data from the HD 210 by erasing address information for reading the actual data even though the actual data itself is not erased, and any method of erasing may be used as long as it can be implemented herein. The shutdown processing also includes processing (cancel processing) that cancels processing of a job currently processed or a job in a waiting state. For example, shutdown processing also includes canceling the printing operation of a job currently being printed, canceling the print processing of a job in a waiting state for printing, and canceling the send processing of a job currently being sent.

In this connection, the configuration may be such that at least any one of these plurality of processing operations (processing to cancel a job and processing to erase the data of the job in question from the HD 210) is taken as the shutdown processing, or the configuration may take processing other than these as the shutdown processing. In any case, any configuration may be adopted as long as the configuration is one that enables the apparatus 102 to execute, as shutdown processing, processing that can put the Multi Function Peripheral 102 into a state in which a problem does not occur therein even if the user shutdowns the main power supply of the Multi Function Peripheral 102.

Further, as described in the foregoing, when only the main power switch is ON, although the apparatus can enter a sleep mode, even in that state the receipt of data from a personal computer that is connected thereto or the receipt of a facsimile is enabled. Then, once the receipt of data is confirmed the apparatus is restored to the normal state from the sleep mode.

### <Shutdown Mode>

In the digital Multi Function Peripheral of this embodiment, when the control part 207 (shutdown control part 212) detects and confirms based on information from a console detector sensor (not shown in the figures) that the console power switch was pressed for a certain time period (for example, five seconds) by a user, the control part conducts control to shift the state of the digital Multi Function Peripheral 102 into the shutdown mode.

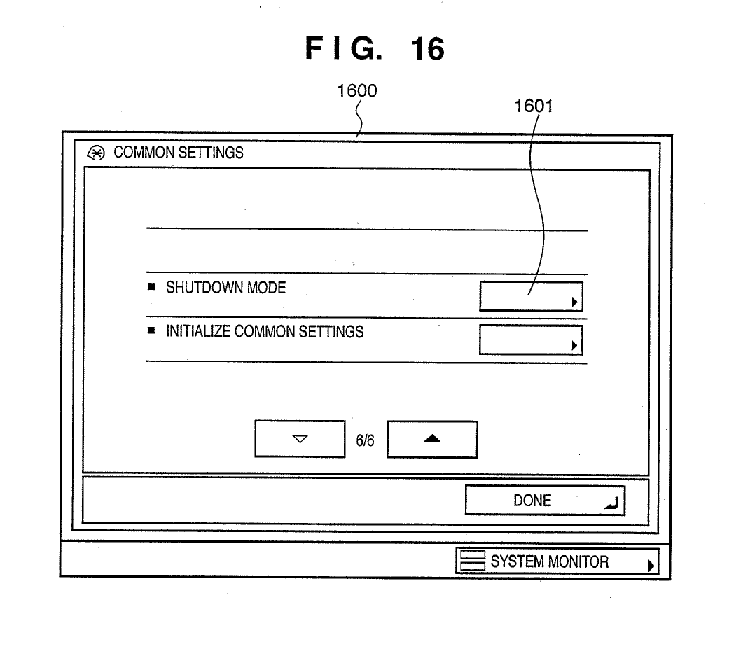

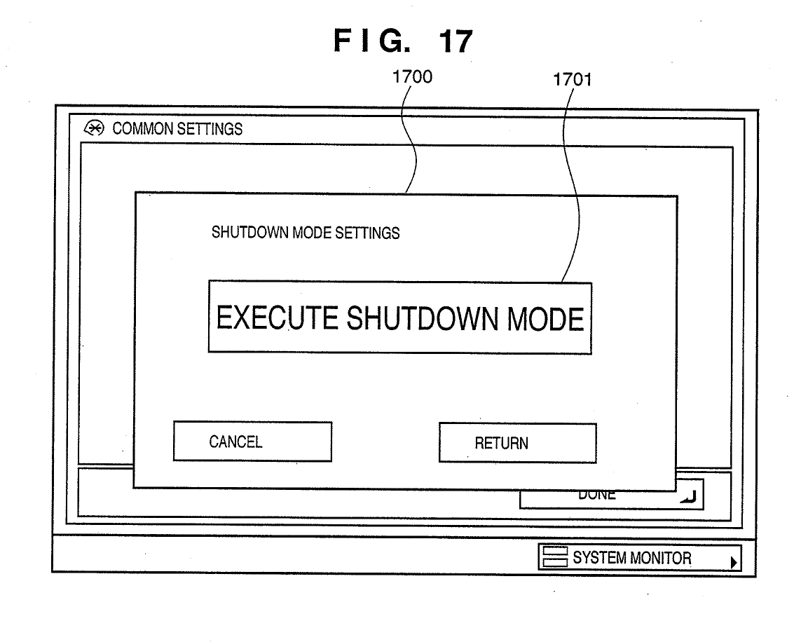

According to this embodiment, when the additional functions key (this is a mechanically hard key) that is provided on the console 203 is pressed by a user, the control part 207 displays a common settings screen 1600, such as that shown in FIG. 16, on the display part 301. Then, in response to a shutdown mode key 1601 on the screen 1600 being pressed by the user, the control part 207 displays a shutdown mode settings screen 1700 shown in FIG. 17 on the display part 301. When a shutdown performing key 1701 on the shutdown mode settings screen 1700 of FIG. 17 is pressed, the control part 207 also performs control to shift the state of the digital Multi Function Peripheral 102 into the shutdown mode. Alternatively, the configuration may be such that without displaying the screen of FIG. 17, the state of the digital Multi Function Peripheral 102 is shifted to the shutdown mode when the shutdown mode key 1601 of the screen 1600 of FIG. 16 is pressed.

In this connection, even if the operating procedures are not followed as described above, a screen transition method may be employed such as, for example, displaying the shutdown mode settings screen 1700 of FIG. 17 on the display part 301 in response to a user pressing the system monitor key displayed on the screen of FIG. 4 or the like.

Thus, although there are various methods for shifting the state of the digital Multi Function Peripheral 102 into shutdown mode, it is sufficient that the apparatus have at least one of a configuration that shifts the state thereof to shutdown mode when the user explicitly inputs an instruction to execute the shutdown mode (for example, a configuration that shifts the state to the shutdown mode when the user presses an execution instruction key for the shutdown mode on the screen of FIG. 16 or FIG. 17) and a configuration that shifts the state to the shutdown mode when other conditions are met without the user explicitly inputting an instruction to execute the shutdown mode (for example, a configuration that enables the apparatus to shift to the shutdown mode when a predetermined condition is met, such as the console power key being pressed by a user for a predetermined time period, even though the execution instruction key for shutdown mode on the screen of FIG. 16 or FIG. 17 is not pressed).

At this point, in accordance with which kind of operating procedures or in accordance with which predetermined conditions being met should the state of the apparatus be shifted to the shutdown mode is determined by the control part (particularly, the shutdown control part 212) on the basis of the operations associated with turning off the main power supply of the digital Multi Function Peripheral 102 that are performed by an operator (user) or are attempted by an operator. Then, the control described later herein can be executed.

In a case where the control part 207 (particularly, the shutdown control part 212) shifted the state of the digital Multi Function Peripheral 102 to the shutdown mode and confirmed that there is a job currently executed (job currently processed) and a job in a waiting state (job waiting to be processed) based on, for example, job information such as information in the administration table 1500 of FIG. 15, it carries out control to display a shutdown confirmation screen on the liquid crystal display part 301.

When the control part 207 (particularly, the shutdown control part 212) confirmed that an operator is executing (or executed, or is attempting to execute) operations to shutdown (turn off) the main power supply of the digital Multi Function Peripheral 102 on the basis of operations performed by the operator with respect to the digital Multi Function Peripheral 102 (for example, based on the detection of operations by the user, such as detecting that the user kept the console power key pressed for a fixed time period or detecting that the shutdown mode execution instruction of FIG. 16 or FIG. 17 was input by the user), at that time, in a case where the control part confirms the existence of a job currently processed or a job in a waiting state (job waiting to be processed) on the digital Multi Function Peripheral 102 based on, for example, the aforementioned job information using the HD 210, even though the user is attempting to shutdown the main power supply of the Multi Function Peripheral 102, the control part 207 (particularly, the shutdown control part 212) carries out control to notify to the user by means of a notification unit such as the display part 301 information to enable the user to ascertain and confirm that there is a job being currently executed by the Multi Function Peripheral 102.

Further, if there is also a job in a waiting state on the Multi Function Peripheral 102, the control part 207 (particularly, the shutdown control part 212) carries out control to additionally notify to the user by means of a notification unit such as the display part 301 information to enable the user to ascertain and confirm that there is also a job in a waiting state. Furthermore, based on the aforementioned job information and operation confirmation information from each unit, the control part also carries out control to notify to the user by means of a notification unit such as the display part 301, in addition to the foregoing information, information to enable the user to ascertain and confirm which functions those jobs are using, to whom the jobs belong and what is the current processing state of the jobs and the like. Also, according to this embodiment, if there is a job currently executed and a job in a waiting state when a user attempts to turn off the main power supply, and a job corresponding to a secured print job exists among those jobs, the control part also carries out control to notify to the user by means of a notification unit such as the display part 301, in addition to the foregoing various kinds of information, information to enable the user to ascertain and confirm the existence of the secured print job.

Thus, according to this embodiment, when a job currently processed or a job in a waiting state exists in a memory unit such as the HD 210 at the time a user performs operations to shutdown the main power supply of the digital Multi Function Peripheral 102, control is conducted to notify to the user by means of a notification unit such as the display part 301 information to enable the user to ascertain and confirm that fact (for example, control to display a shutdown confirmation screen on the display part 301, as described later). It is thus possible to prevent the occurrence of the kinds of problems that have been pointed out for the prior art. In this connection, although the display part 301 is given as an example of a notification unit according to this embodiment, a notification unit other than this may also be used. For example, the configuration may be one which, as another form of a notification unit, notifies this kind of information to a user by audio output using an audio unit.

However, according to this embodiment, just because a job that can be printed or sent exists on the HD 210 at the Multi Function Peripheral 102 when the user performs an operation to turn off the main power supply of the Multi Function Peripheral 102, that fact is not necessarily notified to the user.

For example, by using the mail box function on the Multi Function Peripheral 102 it is possible to store a plurality of jobs that can be printed or sent in the HD 210, and furthermore, these can be stored as they are in the HD 210 as long as an erase instruction is not explicitly input by the user. These types of jobs could also possibly be referred to as jobs in a waiting state. However, even if the main power supply of the Multi Function Peripheral 102 is shutdown by the user, control is carried out to hold jobs corresponding to these types of jobs without erasing them from the HD 210, and furthermore, even after the main power supply of the Multi Function Peripheral 102 is turned on (activated) again by the user, control is carried out to enable these mail box function jobs to be read from the HD 210 and printed or sent in response to an instruction from the user.

Therefore, according to this embodiment, when these kinds of jobs, that is, jobs that were stored in a memory unit such as the HD 210 before the main power supply of the Multi Function Peripheral 102 is turned off by a user, and further, can be read from the memory unit and printed or sent even after the main power supply of the Multi Function Peripheral 102 is turned on again by the user, exist in the Multi. Function Peripheral 102, control is performed so that information relating to jobs corresponding to these types of jobs is not notified to the user by a notification unit such as the display part 301, even if the user performs an operation to turn off the main power supply of the Multi Function Peripheral 102.

For example, even if the control part 207 (particularly, the shutdown control part 212) confirmed the existence of these types of jobs based on job information of the administration table of FIG. 15 or the like, control is carried out so that information relating to these types of jobs is not displayed on the display part 301 for the shutdown confirmation screen described later herein.

Thus, according to this embodiment, in addition to the above control, when jobs exist that were stored in a memory unit such as the HD 210 when the main power supply of the Multi Function Peripheral 102 was in an ON state, and further that can be read from the memory unit and printed or sent in response to an instruction from a user after the main power supply of the Multi Function Peripheral 102 is turned on again from an OFF state, even if the user performs an operation to turn off the main power supply of the Multi Function Peripheral 102, at that time control is carried out so that information relating to these types of jobs is not notified to the user by a notification unit (i.e. processing to notify information relating to these types of jobs is inhibited). In this embodiment this type of job is referred to as a “job to be held after powering off”.

Thus, a configuration can be employed that does not provide more than the required amount of information to a user, and effects can be achieved that can prevent the occurrence of problems such as, in an attempt to solve the problems of the prior art, notifying the user of the information of all jobs stored in a memory unit of the Multi Function Peripheral 102, such as the HD 210, when the user attempts to turn off the main power supply of the Multi Function Peripheral 102, as a result of which, conversely, the user becomes perplexed and operability decreases.

In this connection, a job that is an object for notification of information (a job to be displayed on a job list on the shutdown confirmation screen) by a notification unit such as the display part 301 when the user performs an operation to turn off the main power supply of the Multi Function Peripheral 102, as described in the foregoing control example, is referred to as a “job not to be held after powering off”.

In this embodiment, a job corresponding to a job not to be held after powering off is a job that is stored in a memory unit such as the HD 210 when the main power supply of the Multi Function Peripheral 102 is in an ON state and, further, is a job that is an object of control to erase the job from the HD 210 by the shutdown mode of this embodiment when an operation to turn off the main power supply of the Multi Function Peripheral 102 is performed by a user, and furthermore is a job that, after the main power supply of the Multi Function Peripheral 102 is returned to an ON state again from an OFF state by a user operation, is the object of control that prevents the job being read from the HD 210 to undergo print processing or sending processing.

To summarize the foregoing, according to this embodiment, if jobs currently executed or jobs in a waiting state exist when an operation associated with powering off the main power of the Multi Function Peripheral 102 (an operation in which a user presses the console power key for a fixed time period or more, or an operation in which a user inputs an instruction to shift the state of the apparatus to the shutdown mode via the user interface screen of FIG. 16 or FIG. 17 or the like) is performed by a user (whether or not this kind of operation was performed may be determined, for example, by the control part 207 on the basis of information from an operation detector sensor provided on the console (not shown in the figures)), control is carried out to notify the user through a notification unit of at least information relating to jobs corresponding to jobs not to be held after powering off among those jobs (i.e. the execution of processing to notify information relating to jobs not to be held after powering off is permitted), and in contrast, for information of jobs corresponding to jobs to be held after powering off, control is carried so that the information is not notified to the user by the notification unit (i.e. the execution of notification processing relating to jobs to be held after powering off is inhibited).

In this connection, control may also be performed that includes the following kinds of job as a job to be held after powering off and that, with regard to a job corresponding to the following, does not notify the job information of the job to a user through a notification unit at the time of powering off.

For example, if the processing of a job of a send/facsimile function is not completed the job can be held on the HD 210 after powering off.

Therefore, in this embodiment, a configuration can be employed to enable control whereby, in a case where the main power supply of the Multi Function Peripheral 102 entered an OFF state from an ON state as the result of a user operation and thereafter the main power supply entered an ON state again as the result of a user operation, at that time (at the time of turning the power on again), for example, sending processing is executed to automatically read the job that was held on the HD 210 and send the job using a communication unit such as the FAX communication control part 208 or the network I/F in accordance with the processing conditions (destination settings, sending method settings and the like) that existed before the main power supply was turned off, with the desired sending processing conditions that the user set before the main power supply was turned off.

Thus, a configuration can be employed that, when powering on of the main power of the Multi Function Peripheral 102 is performed again, recovery processing can be automatically executed for network sending function jobs or facsimile sending function jobs.

Therefore, even if these types send/facsimile function jobs exist on the HD 210 at the time of powering off of the main power supply of the Multi Function Peripheral 102, control may be performed that takes these jobs as jobs to be held after powering off, so that information relating to these jobs is not notified to the user by the notification unit at the time of powering off (execution of processing to notify information relating to jobs to be held after powering off is inhibited).

However, even in the case of the above-described configuration, for example, the following type of control may be carried out in consideration of the circumstances and controls described hereunder.

For example, when sending a job to another apparatus using the send/facsimile function, particularly for a job using the facsimile function, a data communication charge arises when communicating data with the other apparatus. In this case, the communication charge arises from the stage of commencing the communication of data to the other party, and no communication charge arises in the stages prior to commencing the communication of data. In this connection, when sending the data of a job via a network using a network sending function, a sending charge does not particularly arise.

Therefore, in a case where the main power supply of the Multi Function Peripheral 102 is shutdown due to a user operation during processing of a facsimile function job, in order to prevent as much as possible the occurrence of an unnecessary communication charge, control is performed that cancels the data communication processing and erases the job from the HD 210 before the main power supply is shutdown by the user, and does not perform a recovery operation for the sending processing of the job even if the main power supply is turned on again. However, if a facsimile function job is present on the HD 210 as a job in a waiting state, since a communication charge has not yet arisen for that job at the time of powering off, control is carried out that holds the job on the HD 210, and when the power is turned on again, enables the job to be read automatically or manually from the HD 210 for the execution of sending processing (since processing of this job starts when the power is turned on again and a communication charge first arises at that point, even if the main power supply was shutdown an unnecessary communication charge does not arise).

Based on this type of configuration, for example, in a case where a job currently processed or a job in a waiting state exists at the time the main power of the Multi Function Peripheral 102 is being turned off by a user operation, if the job currently processed is a job of the facsimile sending function, control is performed that takes the job as a job corresponding to a job that is an object for which a charge relating to data communication is being incurred at the time of shutting down the main power supply, so that the job can be erased from the HD 210 by execution of the shutdown mode and, in addition, control is carried out immediately before shutting down the main power supply (immediately before performing execution of the shutdown mode) that, similarly to the aforementioned control, takes that job as a job not to be held after powering off and notifies the user of the information of that job through a notification unit (i.e. the execution of processing to notify information relating to a job not to be held after powering off is permitted).

Further, for example, in a case where a job currently processed or a job in a waiting state exists at the time the main power of the Multi Function Peripheral 102 is being turned off by a user operation, if the job currently processed is a network sending function job, since the job is not erased from the HD 210 even if the main power supply is shutdown because the job is taken as one corresponding to a job for which a charge relating to data communication does not arise in the first place and is a job for which control is conducted to enable execution of sending processing automatically when the power is turned on again, control is carried out that takes this job as a job to be held after powering off so that information relating to this job is not notified to the user by the notification unit (i.e. the execution of notification processing relating to a job to be held after powering off is inhibited).

Furthermore, for example, if a facsimile sending function job exists on the HD 210 as a job in a waiting state and not a job currently processed at the time the main power of the Multi Function Peripheral 102 is being turned off by a user operation, since that job is not erased from the HD 210 even if the main power supply is shutdown because it is a job that at least corresponds to a job for which a charge relating to data communication has not yet arisen at the time of shutting down the main power supply and is a job for which control is performed to enable sending processing to be automatically executed when the power is turned on again, control is carried out so that the job is treated as a job to be held after powering off and information relating to the job is not notified to a user by the notification unit (i.e. the execution of notification processing relating to a job to be held after powering off is inhibited).

Further, even if a network sending function job exists as a job in a waiting state on the HD 210, since the job is not erased from the HD 210 even if the main power supply is shutdown because the job is taken as one corresponding to a job for which a charge relating to data communication does not arise in the first place and is a job for which control is conducted to enable execution of sending processing automatically when the power is turned on again, control is carried out that takes this job as a job to be held after powering off so that information relating to this job is also not notified to the user by the notification unit (i.e. the execution of notification processing relating to a job to be held after powering off is inhibited).

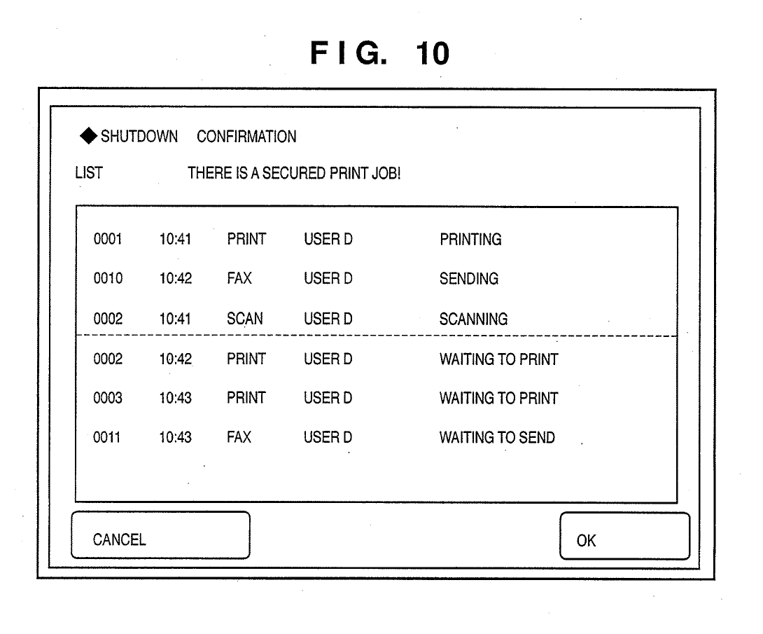

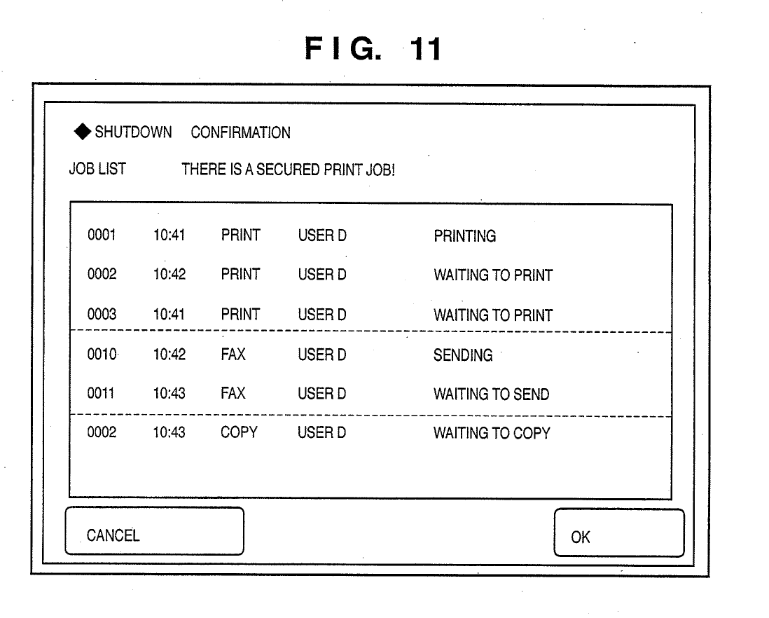

The image forming apparatus 102 of this embodiment may also be configured as follows. For example, on the user interface screen (shutdown confirmation screen) of FIG. 10 or FIG. 11 as described later, control is carried out to store data of a job that is an object for notification of information to a user in a predetermined storage area, known as a temporary region, provided inside the HD 210 to temporarily store image data in order to execute processing desired by a user. Then, for the image data that was stored in the temporary region, control is enabled to erase the image data from the HD 210 at, at least, any one of the times of the group consisting of the time of completion of the job, the time of cancellation of the job, the time of shutting down the main power supply of the digital Multi Function Peripheral 102, and the like.

Further, a predetermined storage area, called a mail box area, for handling jobs as objects for processing by the mail box function of the apparatus 102 is also provided within the HD 210. Control is carried out to enable data of jobs as objects for processing by the mail box function to be stored in the mail box area. Image data stored in the mail box area is controlled so that as long as a user does not input an instruction to erase the image data with the mail box function through, for example, the console 203, the image data is not erased from the HD 210. Further, even if a job to print or send image data of the mail box area is completed or cancelled, control is conducted so that the image data is not erased from the HD 210, and even if the main power supply of the Multi Function Peripheral 102 is shutdown the data is held as it is on the HD 210, and after the power is turned on again the image data of the mail box area can be read for printing and sending.

Based on this type of configuration, although control is conducted by the control part 207 to permit the notification of information relating to a job of image data that was stored in the temporary region of the HD 210 to a user through the shutdown confirmation screen of FIG. 10 or FIG. 11 when shutting down the power, control may also be conducted by the control part 207 to inhibit the notification of image data stored in the mail box area of the HD 210 and/or information relating to the job of that image data to a user through the shutdown confirmation screen of FIG. 10 or FIG. 11 when shutting down the power.

Thus, by enabling various kinds of practical controls to be implemented by the digital Multi Function Peripheral 102, not only are the problems that were described above regarding the prior art solved, but effects can also be achieved such as meeting various user needs and providing a convenient environment that enhances operability for the user.

In this connection, as the above described controls are specifications that take into account the convenience of the user, it is not always necessary for the digital Multi Function Peripheral 102 to be equipped with this type of configuration, and it may be sufficient that the digital Multi Function Peripheral 102 can implement only the previously described type of control.

Next, a description is given regarding a shutdown confirmation screen that is displayed on the display part 301 as one example of a notification unit, immediately prior to the main power supply being actually shutdown (before executing shutdown processing through the shutdown mode) when operations for powering off the main power of the digital Multi Function Peripheral 102 were performed by a user.

This embodiment comprises two kinds of display methods, namely, a first shutdown screen and a second shutdown screen, as a shutdown confirmation screen.

The first shutdown confirmation screen is configured so that, in order to notify a user of the information of a plurality of jobs including jobs currently executed and jobs in a waiting state before the main power supply of the digital Multi Function Peripheral 102 is shutdown by the user, the job information of each of the plurality of jobs is displayed sequentially in list format with the information of the jobs currently executed at the top part of the display area (top part of the window) and the information of the jobs in a waiting state displayed thereunder.

The second shutdown confirmation screen is configured so that, before the main power supply of the digital Multi Function Peripheral 102 is shutdown by a user, the information of jobs currently executed and jobs in a waiting state is displayed sequentially in a list that is classified (sorted) according to function (for example, print function, facsimile function, copy function), in order to notify the user of the information.

The control part (particularly, the shutdown control part 212) of this embodiment carries out control to display these screens on the display part 301 based on various kinds of job information including information of the administration table of FIG. 15 or the operating state of the Multi Function Peripheral 102.

The setting to determine which of these two shutdown confirmation screens to display can be made by a user, for example, on an initial settings screen (not showm in the figures) that is displayed on the display part 301 in response to the additional functions key of the console 203 of FIG. 3 being pressed by the user.

For example, a first display mode that displays the first shutdown confirmation screen and a second display mode that displays the second shutdown confirmation screen are both presented to the user on the initial settings screen (not shown in the figures) that is displayed on the display part 301 to enable the user to select the desired display mode, after which the control part 207 conducts control to enable the shutdown confirmation screen corresponding to the display mode that was selected by the user to be displayed on the display part 301 under conditions described later. In this connection, a configuration may be adopted that displays only either one of the screens, and even without employing this kind of screen configuration any kind of screen configuration can be used as long as it is a configuration that can notify the information to the user.

FIG. 10 is a view showing an example of the first shutdown confirmation screen that is displayed on the display part 301 by the control part (particularly, the shutdown control part 212) when jobs currently processed or jobs in a waiting state exist on the digital Multi Function Peripheral 102, for example, using the HD 210, at a stage when the main power supply of the digital Multi Function Peripheral 102 is being switched to an OFF state from an ON state by a user operation, in order to notify the user to that effect. On this first shutdown confirmation screen, job information is listed so that jobs currently executed are displayed at the top of the screen.

According to this embodiment, to enhance operability for the user, for example, as shown in the figure, a screen is created that displays jobs currently executed at the top part of the window displaying the job list on the screen and displays the jobs in a waiting state in the lower part. Further, a display configuration is employed that makes a separation between the jobs currently executed and the jobs in a waiting state by use of a chain line or the like, so that the user can readily distinguish the point up to which the jobs are jobs currently executed.

When a print job (for example, a secured print job) exists that is an object of control that does not allow the execution of processing to begin until a predetermined operation including the input of authentication data such as a password (other than a password, the authentication may be by use of an IC card or the like) is performed, the message “there is a secured print JOB” is displayed in a distinctive manner, for example, by a highlighted display, on the upper part of the window or the like to call the user's attention to the fact.

Thus, if jobs currently processed or jobs in a waiting state exist on the Multi Function Peripheral 102 through use of a memory unit such as the HD 210 at the time the user attempts to execute an operation to turn off the main power supply of the digital Multi Function Peripheral 102, the control part (particularly, the shutdown control part 212) enables control to notify the user of information to enable the existence of these jobs to be ascertained and confirmed by the user through a notification unit before the main power supply of the digital Multi Function Peripheral 102 is actually put in an OFF state by the user, and when for example, a job type, such as a secured print job, for which actual processing starts on the condition that an intervening operation including the input of authentication data or the like was conducted by the user is included among these jobs, the control part (particularly, the shutdown control part 212) also conducts control to notify the user of information to enable the fact that this type of job exists to be ascertained and confirmed by the user through the notification unit together with the aforementioned information.

However, according to this embodiment, in a case such as this in which a secured print job exists, control is conducted to allow a user to ascertain and confirm only the fact of the existence of this type of job, and to prevent specific detailed information of the secured print job (for example, information identifying which job is a secured print job among a plurality of jobs, or information enabling a user to identify the name of the job document or user name or the like) being displayed on the display part 301. Thus a high level of security can be maintained. More specifically, a configuration is adopted that does not present the information of the administration table of FIG. 15 to a user in that state, and instead presents information that has been masked to a certain extent.

However, this control is also based on a specification that takes into account a desire to ensure a high level of security, and a configuration need not necessarily be one that can execute this kind of control.

Further, after displaying the shutdown confirmation screen of FIG. 10 on the display part 301, for example, when a user that confirmed information on this screen pressed a “cancel” button displayed at the bottom of the window provided on the shutdown screen of FIG. 10 to enable a user to input an instruction to cancel execution of the shutdown mode, the control part (particularly, the shutdown control part 212) conducts control to inhibit the execution of processing to erase from the HD 210 the data of jobs currently processed and jobs in a waiting state that correspond with the jobs listed on the screen of FIG. 10 by execution of the shutdown mode, controls the operating state of the Multi Function Peripheral 102 to restore the normal operating mode (mode prior to shifting to the shutdown mode) from the shutdown mode, and controls the display part 301 so that the display contents of the display part 301 are also restored to the appropriate operation screen that is different to the screen in question.

For example, as the appropriate operation screen, the operation screen that was displayed on the display part 301 immediately prior to displaying the shutdown mode confirmation screen of FIG. 10 on the display part 301 and which the operator operated immediately prior to shifting to the shutdown mode is displayed on the display part 301. Further, for example, control is performed to close the shutdown confirmation screen of FIG. 10 and display the initial screen of the function that is preset as the initial setting of the digital Multi Function Peripheral 102 (for example, as shown in FIG. 4, if the copy function is preset as the function to be automatically activated when the power is turned on, the initial screen of the copy function of FIG. 4 is displayed) on the display part 301, and control is performed to enable operations performed by the user when the Multi Function Peripheral 102 is in a normal state (for example, a state in which the digital Multi Function Peripheral 102 is not in a sleep state, but is in a ready state such as a state in which printing can be performed, in which all units are in an energized state) to be accepted through the console 203.

In contrast, when an “OK” button that is provided on the shutdown confirmation screen of FIG. 10 displayed on the display part 301 to enable a user to input an instruction to execute the shutdown mode is pressed by the user, the control part 207 (particularly, the shutdown control part 212) performs control to notify the user through the notification unit of information (including information to enable the user to ascertain and confirm that the shutdown mode is currently being executed) to enable the user to ascertain and confirm the fact that the shutdown mode is being executed by the Multi Function Peripheral 102, and also performs control to cause shutdown processing to be executed by the shutdown mode.

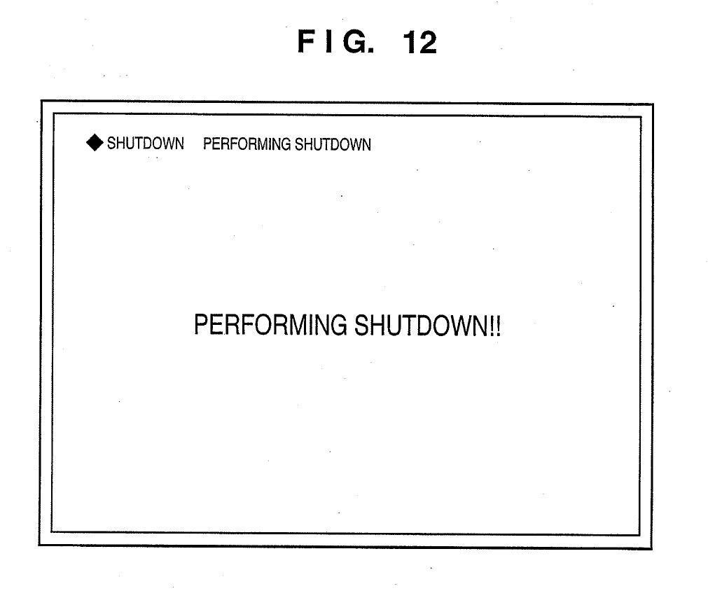

As one example of this notification control, for example, the control part 207 (particularly, the shutdown control part 212) performs control to display on the display part 301 the shutdown performing screen shown in FIG. 12 containing the information in question.

Further, as shutdown processing, for example, the control part 207 (particularly, the shutdown control part 212) performs control to cause the execution of processing that cancels the processing of jobs currently executed among jobs for which the job information has been presented (shown) to the user through the shutdown confirmation screen of FIG. 10 that correspond to jobs not to be held after powering off that are stored in the HD 210 (in this example, processing that causes the printer part 202 to cancel the printing operation of the job of acceptance number 0001 in the list of FIG. 10 that is currently being printed by the printer part 202, or processing that causes the scanner part 201 to cancel the scanning operation of the job of acceptance number 0002 in the list of FIG. 10 that is currently being scanned by the scanner part 201), and also cause the execution of processing that executes on the HD 210 processing that erases the image data of the jobs currently processed and the respective image data of other jobs in a waiting state that are shown in the list of FIG. 10 from the HD 210, and the like.

In this embodiment, while the control part 207 (particularly, the shutdown control part 212) is displaying the shutdown performing screen of FIG. 12 on the display part 301 (that is, while executing processing to notify information to a user through a notification unit to enable the user to recognize that shutdown processing is being executed by the Multi Function Peripheral 102), it carries out control in parallel with that processing to execute the aforementioned shutdown processing.

In contrast, shutdown processing is not executed at the stage before displaying the shutdown performing screen of FIG. 12 on the display part 301.

For example, during the period (at least, the time period before the OK key of FIG. 10 is pressed by a user) in which information to enable a user to ascertain the fact that jobs not to be held after powering off are currently processed (and/or are in a waiting state) is being notified to the user on the notification unit by displaying the shutdown confirmation screen of FIG. 10 on the display part 301, control is conducted so that shutdown processing is not executed.

Thus, in order to enhance the operating ratio of the digital Multi Function Peripheral 102 as much as possible, in this embodiment the units for processing jobs of the scanner part 201, the printer part 202, the FAX communication control part 208, the network I/F part 209 and the like are controlled by the control part 207 so that they continue to operate until immediately before executing shutdown processing so that the processing of jobs currently processed and processing of jobs in a waiting state that are held on the HD 210 can be completed.

For example, when jobs not to be held after powering off are being processed and/or in a waiting state using a memory unit such as the HD 210 at the time an operation for powering off the main power of the Multi Function Peripheral 102 is performed by a user, even in the course of displaying information to enable this fact to be ascertained by a user through a notification unit (in this example, in the course of displaying the shutdown confirmation screen of FIG. 10 on the display part 301), each unit continues to be operated to continue the processing of these jobs that are the objects of notification in parallel with the notification processing with the purpose of completing the processing.

For the example of FIG. 10, in a state in which the screen of FIG. 10 is displayed on the display part 301 (at least, a state in which an instruction to execute shutdown processing has not been input by the user through use of the OK key of FIG. 10), the control part 207 performs control to continue operation of the printer part 202 so that printing operations of the printer part 202 with respect to the print job currently processed with the acceptance number 0001 at the top of the list of FIG. 10 are continued. Further, simultaneously (in parallel) with the above operation, the control part 207 also maintains the operation of the FAX communication control part 208 to continue facsimile sending operations of the FAX communication control part 208 with respect to the job currently processed for facsimile sending with the acceptance number 0010 that is second from the top of the list of FIG. 10. Furthermore, simultaneously (in parallel) with these operations, the control part performs control to continue operation of the scanner part 201 in order to continue the scanning operations of the scanner part 201 with respect to the scan job currently processed with the acceptance number 0002 that is third from the top of the list of FIG. 10.

The control part 207 controls each unit so that these processing operations continue to be executed until a shutdown performing instruction is input by the user using the OK key of FIG. 10.

More specifically, for the example of FIG. 10, if the printing processing of the job with the acceptance number 0001 at the top of the list of FIG. 10 is completed in a state in which the OK key of FIG. 10 has not been pressed by the user, the job is erased from the HD 210 and the printer part 202 is controlled so that print operations are started for the print job with the acceptance number 0002 that is fourth from the top of the list of FIG. 10 that corresponds to a print job in a waiting state as the print job to be executed next. If the OK key of FIG. 10 has still not been pressed by the time printing operations are completed for this job that is fourth from the top of the list of FIG. 10, the printer part 202 is controlled so that print operations are then started for the print job with the acceptance number 0003 that is fifth from the top of the list of FIG. 10 that corresponds to a job in a waiting state as the print job to be next executed.

Similarly, if the processing to send to another apparatus the job with the acceptance number 0010 which is currently undergoing facsimile sending processing and is second from the top of the list of FIG. 10 is completed in a state in which the OK key of FIG. 10 has not been pressed by the user, the job is erased from the HD 210 and the FAX communication control part 208 is controlled so that sending operations are started for the facsimile sending job with the acceptance number 0011 that is sixth from the top of the list of FIG. 10 that corresponds to a sending job in a waiting state as the facsimile sending job to be executed next.

Performing control is this manner so that the processing of jobs presented to a user continues to be carried out until the time that an instruction to execute shutdown processing is actually input by the user enables the operating ratio and job productivity of the digital Multi Function Peripheral 102 to be enhanced as much as possible until immediately before the main power supply of the Multi Function Peripheral 102 is actually shutdown by the user. Further, for example, in a case where a user that attempted to turn off the main power supply of the Multi Function Peripheral 102 decided to cancel the operation to turn off the main power supply upon viewing the information of the shutdown confirmation screen of FIG. 10 or the like and confirming that jobs not to be held after powering off are currently being processed by the Multi Function Peripheral 102 or are in a waiting state, and thus pressed the cancel key of FIG. 10 to return the digital Multi Function Peripheral 102 to a normal state, since control is also performed in this case to continue to carry out the processing of each job even during the period that the user is making this type of judgment and performing such operations, the productivity of the overall system can be significantly increased.

Therefore, by enabling the aforementioned control to be executed, even in a case where a user turns off the power supply of the digital Multi Function Peripheral 102, effects can be obtained that include enabling the operating ratio and productivity of the digital Multi Function Peripheral 102 to be increased to the utmost.

In this connection, this kind of control configuration is based on a specification that takes into account the productivity and operating ratio of the apparatus, and the apparatus need not necessarily comprise this configuration.

Further, according to this embodiment, the control part 207 (particularly, the shutdown control part 212) is configured to cause the Multi Function Peripheral 102 to execute the above-described shutdown processing on the condition that an instruction to execute shutdown processing was made by a user through the console 203 (for example, the OK key on the shutdown confirmation screen of FIG. 10 or FIG. 11 was pressed).

When the control part 207 (particularly, the shutdown control part 212) decides based on the aforementioned condition to execute shutdown processing, even if the processing of jobs presented to the operator through the shutdown confirmation screen of FIG. 10 or FIG. 11 (corresponding to jobs currently processed and/or jobs in a waiting state at the time a user operation relating to powering off of the main power of the Multi Function Peripheral 102 was performed with respect to the Multi Function Peripheral 102) is not completed, the control part controls each unit (scanner part, communication part, printer part, etc.) to cancel the processing of all jobs listed on the screen and performs control to erase from the HD 210 all the data of each job for which information was presented on the list (these are basically stored in the temporary region of the HD 210).

More specifically, the control part performs control to forcefully cancel the processing of each job currently processed and/or job in a waiting state (jobs not to be held after powering off) for which information was presented on the list, without waiting for the processing of these jobs to be completed.

The present specification is one that takes into consideration the operability for the user. For example, if we assume the case of an office environment or the like in which the time has reached the office closing time and a given operator wishes to leave the office to return home upon shutting down the main power supply (a state in which the apparatus is shutdown, also referred to simply as “an OFF state”) of the Multi Function Peripheral 102 in the office.

In this case, when the configuration is one that does not use the aforementioned control of this embodiment and is one whereby shutdown processing (processing to put the apparatus in a state in which the power may be shutdown) is executed upon completion of the processing of all jobs currently processed and/or jobs in a waiting state, if there is a large amount of jobs currently processed and/or jobs in a waiting state on the Multi Function Peripheral 102, even if the operator wishes to execute shutdown processing quickly, the shutdown processing will not start until all of those jobs have been completed. During that period, it is not possible for the operator to shutdown the main power supply, and even though the operator may want to leave the office quickly, the operator must stay in front of the Multi Function Peripheral 102 and wait for all the jobs to be completed.

Thus, as described above, according to this embodiment a configuration is employed whereby, in order to shutdown the main power supply of the Multi Function Peripheral 102 without delay when the user personally wants execution of shutdown processing to be conducted (when an instruction to execute shutdown processing was input by pressing the OK key of the shutdown confirmation screen of FIG. 10 and FIG. 11) even if the processing of jobs currently processed and/or jobs in a waiting state is not completed by the Multi Function Peripheral 102, control is carried out to forcefully execute shutdown processing and put the apparatus in a state in which the main power supply of the Multi Function Peripheral 102 can be turned off as quickly as possible.

It is thereby possible to prevent the kind of problem assumed above that is likely to occur in an office environment or the like, and to achieve effects such as enabling the provision of a user-friendly apparatus that takes into account the utilization environment of the operator of the Multi Function Peripheral 102.

Further, in order to prevent a problem arising even if this kind of configuration is employed, this embodiment is configured to present the various information described above to the operator on the shutdown confirmation screen of FIG. 10 or FIG. 11 so as to obtain the consent of the operator. At that time, if it is acceptable to execute shutdown processing, the operator can personally input an instruction to that effect through the screen of FIG. 12. In contrast, if the operator, upon confirming the details on the screen of FIG. 10 or FIG. 11, considers it better not to conduct shutdown processing, the operator can personally input an instruction to cancel execution of shutdown processing through the screen of FIG. 12.

Thus, an effect can be achieved that prevents the occurrence of problems such as in a case where even though an operator wants shutdown processing for the Multi Function Peripheral 102 to be executed without delay, the operator who wants to turn off the main power supply of the Multi Function Peripheral 102 is needlessly confined in front of the Multi Function Peripheral 102 because shutdown processing for the Multi Function Peripheral 102 cannot be started due to the fact that a job currently processed or a job in a waiting state is present in the Multi Function Peripheral 102. It is also possible to achieve an effect such as enabling prevention of the occurrence of problems that arise in an attempt to solve the above kind of problem, such as a case in which, even though an operator does not want shutdown processing to be executed, the Multi Function Peripheral 102 arbitrarily starts shutdown processing based on its own decision. These two effects can be achieved in a compatible manner while flexibly corresponding to the needs of the user.

FIG. 11 is a view showing an example of the second shutdown confirmation screen that is displayed on the display part 301 by the control part (particularly, the shutdown control part 212) when jobs currently processed or jobs in a waiting state that correspond to jobs not to be held after powering off exist on the digital Multi Function Peripheral 102, for example, using the HD 210, at a stage when the main power supply of the digital Multi Function Peripheral 102 is being switched to an OFF state from an ON state by a user operation, in order to notify the user to that effect. On this second shutdown confirmation screen, the jobs are listed by classifying the jobs according to function. Only the contents displayed in the window displaying the job list on the screen are different to the first shutdown confirmation screen shown in FIG. 10, and the other parts are the same as the first shutdown confirmation screen.

In the second shutdown confirmation screen, as shown in the figure, display control is conducted to display jobs currently executed and jobs in a waiting state by separating them according to the respective functions (processing), such as the print, facsimile, and copy functions. Further, control is conducted such that the screen is configured to make a separation between each of the functions in the display by use of chain lines or the like and such that the job currently executed is displayed at the top of the display region of each function. Thus, the user can readily distinguish which jobs are currently being executed and which jobs are in a waiting state, as well as to which functions those jobs belong.

When there are, at least, no jobs corresponding to jobs not to be held after powering off (jobs for which control is performed so that the jobs cannot be read from the HD 210 to execute printing or sending after the main power supply is turned on again) and no jobs currently executed or jobs in a waiting state on the digital Multi Function Peripheral 102 at the time of shifting to the shutdown mode, the shutdown performing screen of FIG. 12 is displayed and shutdown processing is executed without displaying these shutdown confirmation screens.

A configuration may also be employed that, when these kinds of jobs do not exist, causes information indicating that fact to be notified to the user through a notification unit to inform the user that no such jobs exist for confirmation purposes.

Further, on the shutdown confirmation screen of FIG. 11 or FIG. 12, information specifying the fact that a job displayed in the list is a job not to be held after powering off is not displayed on the screen.

In this embodiment, furthermore, for example, a configuration may be employed that controls a notification unit so that at least one of the following types of information is notified to the user in addition to the foregoing various kinds of information: message information to enable an operator to confirm that a job on the list of the screen of FIG. 11 or FIG. 12 is a job not to be held after powering off; message information to enable an operator to confirm that a job on the list is a job that will be erased from the HD 210 when the power is shutdown by the shutdown processing; message information to enable an operator to confirm that a job on the list is a job for which processing will be cancelled by the shutdown processing; and message information to enable an operator to confirm that a job on the list is a job for which recovery processing will not be automatically executed when the power is turned on again, and the like.

In this manner, the effects described above can be further enhanced. In this case, for example, a configuration may be adopted that additionally displays information indicating such facts to the user as a message on the shutdown confirmation screen of FIG. 11 or FIG. 12.

### <Display Processing of First Shutdown Confirmation Screen>

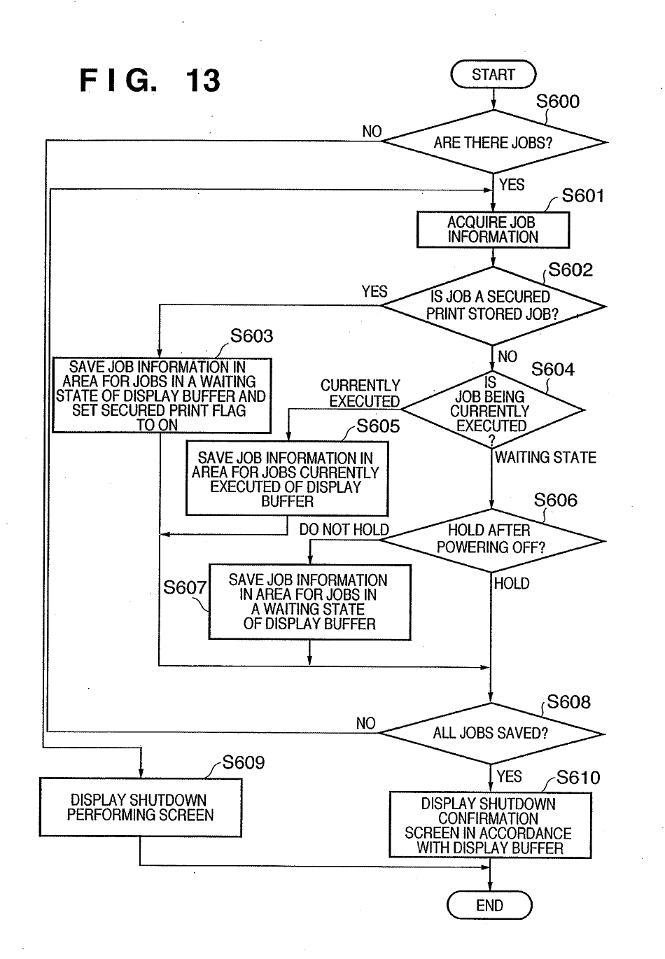

Processing that displays the first shutdown confirmation screen is now described referring to the flowchart of FIG. 13.

When the digital Multi Function Peripheral 102 shifts into shutdown mode in response to a user operation as described above (for example, in response to the control part determining that the console power key (not shown in the figures) on the console 203 was pressed continuously by a user for a fixed time period based on information from a console detector sensor (not shown) of the console 203, or in response to a user explicitly inputting an instruction to execute the shutdown mode by pressing the additional functions key of the console 203 and pressing a shutdown key 1601 of the screen of FIG. 16 or a key 1701 of FIG. 17 or the like), in step S600 the shutdown control part 212 inside the system control part 207 determines whether or not there are jobs currently executed and jobs in a waiting state, for example, by referring to job information written in the job administration table 1500 of FIG. 15 or the like, or based on detection information of the operating status of each unit that is received from each unit. When jobs currently executed and jobs in a waiting state exist, the operation moves to step S601, and when they do not exist the operation moves to step S609.

In step S601, in order to perform job processing one by one for jobs currently executed and jobs in a waiting state, the information of one job is acquired from, for example, the aforementioned information of the administration table 1500 or information indicating the operating status of each unit. Next, in step S602, based on the acquired job information the control part determines whether or not the job is a job that exists in a stored state in the HD 210 as a job for printing but remains as a job waiting for execution until there is intervention by the user (a job for which processing is not started unless authentication processing is performed), such as, for example, a secured print job. When the job is a stored job the operation moves to step S603. In contrast, when the job is not a stored job the operation moves to step S604.

In step S603, the control part saves job information that was acquired in the preceding step in a save area for jobs in a waiting state in a save buffer of the display memory or the HD 210 for the display window of FIG. 10, and also sets to ON a flag that indicates the presence of a job in a stored state, for example, a secured print flag (for example, if the administration table 1500 of FIG. 15 or the like is used, a flag is set as in FIG. 15). In step S604, from the acquired job information the control part determines whether or not the job is currently being executed, and when the job is currently being executed the operation moves to step S605. If the job is in a waiting state the operation moves to step S606. In this case, the post-processing phase after job execution is included in the current execution of a job.

In step S605, the control part saves the acquired job information in a save area for jobs currently executed within the save buffer for the display window. In step S606, based on the acquired job information the control part determines whether or not the job is a job to be held after powering off, that is, a job to be executed when the power is activated again after being shutdown (for example, a job processed by a network sending function). When the job is a job not to be held after powering off, that is, a job to be erased (canceled) in the shutdown processing (for example, a copy function job, a print function job, a facsimile receiving function job, a secured print function job or the like), the operation moves to step S607, and when the job is a job to be held after powering off the operation moves to step S608.

In this connection, the setting for whether or not to hold a job after powering off can be made by a user when inputting a job. Further, even if the user does not make an explicit setting, by acquiring information from each unit the control part may determine which type of job the job in question is by identifying which input route the job was input from, for example, whether the job is a job that was input from the scanner part 201, a job that was received through the facsimile communication part 208, a job that was input from the network I/F 209 or the like. Based on the determination result, the control part can identify the job type and use that result to decide whether to handle the job as a job to be held after powering off or as a job not to be held after powering off, and may utilize the result of the decision in the processing of the present flowchart.

In step S607, the control part saves the acquired job information in a save area for jobs in a waiting state within the save buffer for the display window. In step S608, the control part determines whether or not information for all of the jobs currently executed and jobs in a waiting state (other than jobs to be held after powering off) was saved in the save buffer for the display window. When the control part determines that all the jobs were saved the operation proceeds to step S610, and when the control part determines that there is a job that has not yet been saved the operation returns to step S601 to repeat the subsequent processing.

In step S610, by first sending the information of the area for jobs currently executed that was stored in the save buffer for the display window and then sending the information of the area for jobs in a waiting state to the console display 203 (liquid crystal display part 301), as shown in FIG. 10, the control part controls the display part 301 so that a list of jobs is displayed with the jobs currently executed displayed at the top of the list and the jobs in a waiting state displayed thereunder. Further, if the secured print flag is set to ON, the control part controls the display part 301 so that, in a separate region to the displayed list of jobs, the display part 301 displays information to the effect that there is a secured print job to the user in a conspicuous manner, such as a highlighted display or the like, to enable the fact to be ascertained by the user.

In contrast, in step S600, if the control part determines that there are no jobs currently executed or jobs in a waiting state, the control part controls the display part 301 so as not to display the first shutdown confirmation screen, and in step S609, to display the shutdown performing screen shown in FIG. 12.

### <Display Processing of Second Shutdown Confirmation Screen>

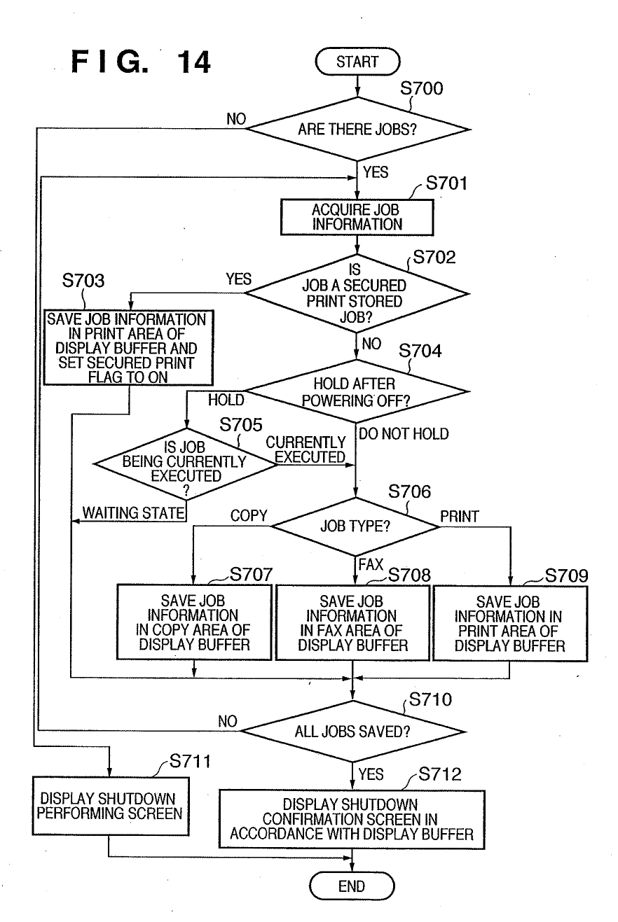

Processing that displays the second shutdown confirmation screen is now described referring to the flowchart of FIG. 14.

When the digital Multi Function Peripheral 102 shifts into the shutdown mode in response to a user operation as described above (for example, in response to the fact that the console power key (not shown in the figures) on the console 203 was pressed continuously by a user for a fixed time period being determined based on information from a console detector sensor (not shown) of the console 203, or in response to a user explicitly inputting an instruction to execute the shutdown mode by pressing the additional functions key of the console 203 and pressing a shutdown key 1601 of the screen of FIG. 16 or a key 1701 of FIG. 17 or the like), in step S700 the shutdown control part 212 inside the system control part 207 determines whether or not there are jobs currently executed or jobs in a waiting state, for example, by referring to job information written in the job administration table 1500 of FIG. 15 or the like, or based on detection information of the operating status of each unit that is received from each unit. When jobs currently executed or jobs in a waiting state exist, the operation shifts to step S701, and when they do not exist the operation shifts to step S711.

In step S701, in order to perform job processing one by one for jobs currently executed and jobs in a waiting state, the information of one job is acquired from, for example, the aforementioned information of the administration table 1500 or information indicating the operating status of each unit. Next, in step S702, based on the acquired job information the control part determines whether or not the job is a job that exists in a stored state but remains as a job waiting for execution until there is intervention by the user, such as, for example, a secured print job. When the job is a stored job the operation moves to step S703. In contrast, when the job is not a stored job the operation moves to step S704.

In step S703, the control part saves the acquired job information in a save area for jobs in a waiting state in a save buffer for the display window of FIG. 11, and also sets to ON a flag that indicates the presence of a job in a stored state, for example, a secured print flag. In step S704, based on the acquired job information the control part determines whether or not the job is a job to be held after powering off, i.e. a job to be executed when the power is activated again after being shutdown. When the job is a job not to be held after powering off, i.e. a job to be erased (canceled) in the shutdown processing, the operation moves to step S706, and when the job is a job to be held after powering off, the operation moves to step S705. In this connection, the setting of whether or not to hold a job after powering off can be made by the user when inputting the job. In this case, the post-processing phase after job execution is included in the current execution of a job.

In step S705, based on the acquired job information the control part determines whether or not the job is currently being processed. When the job is currently being processed the operation moves to step S706, and when the job is in a waiting state the operation moves to step S710.

In step S706, based on the acquired job information the control part determines whether the job is a copy job, a FAX job, a print job or the like, for example, by referring to job information in the aforementioned administration table 1500 or information indicating the operating status that is received from each unit. When the job is a copy job the operation moves to step S707, when it is a FAX job the operation moves to step S708, and when it is a print job the operation moves to step S709.

In step S707, the control part saves the acquired job information in a save area for copy jobs in the save buffer for the display window. In step S708, the control part saves the acquired job information in a save area for FAX jobs in the save buffer for the display window. Likewise, in step S709, the control part saves the acquired job information in a save area for print jobs in the save buffer for the display window.

In step S710, the control part determines whether or not information for all of the jobs currently executed and jobs in a waiting state (other than jobs to be held after powering off) was saved in the save buffer for the display window. When the control part determines that all the jobs were saved the operation proceeds to step S712, and when the control part determines that there is a job that has not yet been saved the operation returns to step S701 to repeat the subsequent processing.

In step S712, by sending the information that was stored in the save buffer for the display window for each type of job in the order of, for example, print job area, FAX job area and copy job area, to the console display 203 (liquid crystal display part 301), as shown in FIG. 11, the control part controls the display part 301 so that a job list is displayed in which jobs are classified according to the type of each job. Further, for example, if the control part determines, as a result of checking the contents of the administration table 1500, that the secured print flag in ON, the control part also controls the display part 301 so that, in a separate region to the displayed job list, the display part 301 displays information to the effect that there is a secured print job, in a conspicuous manner such as a highlighted display.

In contrast, in step S700, if the control part determines that there are no jobs currently executed or jobs in a waiting state, the control part controls the display part 301 so as not to display the second shutdown confirmation screen, and in step S711, to display the shutdown performing screen shown in FIG. 12.

As described in the foregoing, according to this embodiment a shutdown mode is executed before shutting down the power supply of the main body of the apparatus. On the shutdown confirmation screen jobs currently executed and jobs in a waiting state that will be cancelled when shutdown is executed are displayed to the user in an easily understandable manner. When a job has been input that will not be executed unless the user performs a predetermined operation, such as a secured print job, the existence of that type of job is indicated to the user in a conspicuous manner.

Therefore, by simply looking at the job list that is displayed on the shutdown confirmation screen, a user can easily ascertain the existence or non-existence of jobs that will be affected by shutdown processing (jobs for which processing will be cancelled or jobs for which data will be erased from a memory such as the HD 210 when the main power supply of the Multi Function Peripheral 102 is turned off) as well as the job contents (contents that enable the user to identify which function a job belongs to, what is the document name of a job, to which user a job belongs, what the current processing condition of a job is, and the like). Thus, it is possible to prevent the unintended interruption or cancellation of a job when performing shutdown processing.

### Other Embodiments

In the embodiment described above, although only information of jobs that will be affected (interrupted or cancelled) by shutdown processing is displayed, a configuration may be adopted that displays the information of all the input jobs (for example, all jobs that are stored in the HD 210). In that case, preferably control is conducted to cause the display part 301 to implement a display that allows the user to easily distinguish the jobs that will be affected by shutdown processing from the jobs that will not be affected by shutdown processing.

Further, as long as the display format is one that enables a user to easily ascertain the existence or non-existence of jobs that will be affected by shutdown processing as well as the contents of the jobs, the information of jobs that will be affected by shutdown processing may be displayed in a format that is different to the format described in the foregoing.

In addition, instead of displaying information concerning the existence or non-existence of jobs that will be affected by shutdown processing as well as the contents of the jobs on the console display 203 (liquid crystal display part 301), a configuration may be adopted that prints out this information in a predetermined format. More specifically, a configuration may be adopted that outputs information to the same effect as the information that is notified to a user using the screen FIG. 11 or FIG. 12, on a recording paper from the printer part 202 as a notification unit for notifying information.

Furthermore, when there are no jobs that will be affected by shutdown processing, control may be conducted to display a screen that explicitly indicates that fact to the user.

The present invention can be applied to a system comprising a plurality of devices or to an apparatus comprising a single device (e.g., digital Multi Function Peripheral).

Furthermore, the invention can be implemented by supplying a software program, which implements the functions of the foregoing embodiments (program corresponding to flowcharts shown in FIGS. 13 and 14), directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention in a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-203706, filed Jul. 9, 2004, which is hereby incorporated by reference.

1.-31. (canceled)

32. A job processing apparatus comprising:
a storing unit which stores jobs of multiple types, wherein the jobs of multiple types include a job of a first type which is erased when the power of the job processing apparatus is turned off, and a job of a second type which is not erased when the power of the job processing apparatus is turned off;
a job processing unit which executes jobs stored in the storing unit;
a notifying unit which notifies a user;
an accepting unit which accepts an instruction for turning off a power of the job processing apparatus;
a shutdown process executing unit which executes a process for turning off the power of the job processing apparatus; and
a controller which, in a case where the job of the first type and the job of the second type are stored in the storing unit when the accepting unit accepts the instruction for turning off the power of the job processing apparatus, controls so as to cause the notifying unit to notify the user of information which indicates the job of the first type but which does not indicate the job of the second type, before the shutdown process executing unit executes the process for turning off the power of the job processing apparatus.

33. The apparatus according to claim 32, wherein the job of the first type is a print job.

34. The apparatus according to claim 32, wherein the job of the second type is a sending job.

35. The apparatus according to claim 32, wherein when the accepting unit accepts a confirmation from the user after the notifying unit notifies the user, the shutdown process executing unit executes the process for turning off the power of the job processing apparatus.

36. A control method for a job processing apparatus comprising a storing unit, a job processing unit which executes jobs of multiple types, a shutdown process executing unit which executes a process for turning off a power of the job processing apparatus, and a notifying unit which notifies a user, comprising:
storing jobs of multiple types in the storing unit, wherein the jobs of multiple types include a job of the first type, which is erased when the power of the job processing apparatus is turned off, and a job of a second type which is not erased when the power of the job processing apparatus is turned off;
accepting an instruction for turning off the power of the job processing apparatus; and
controlling, in a case where the job of the first type and the job of the second type are stored in the storing unit when the accepting step accepts the instruction for turning off the power of the job processing apparatus, so as to cause the notifying unit to notify the user of information which indicates the job of the first type but which does not indicate the job of the second type, before the shutdown process executing unit executes the process for turning off the power of the job processing apparatus.

37. A computer-readable storage medium storing a program that causes a computer to execute the control method according to claim 36.

38. The apparatus according to claim 32, wherein
the jobs of multiple types include a job of a third type which incurs a charge for execution and a job of a fourth type which does not incur a charge for execution, and
wherein in a case where the job of the third type and the job of the fourth type are stored in the storing unit when the accepting unit accepts the instruction for turning off the power of the job processing apparatus, the controller controls so as to cause the notifying unit to notify the user of information which indicates the job of the third type but which does not indicate the job of the fourth type, before the shutdown process executing unit executes the process for turning off the power of the job processing apparatus.

39. The apparatus according to claim 32, wherein
the jobs of multiple types include a job of a fifth type which needs an authentication before execution and a job of a sixth type which does not need an authentication before execution, and
wherein in a case where the job of the fifth type and the job of the sixth type are stored in the storing unit when the accepting unit accepts the instruction for turning off the power of the job processing apparatus, the controller controls so as to cause the notifying unit to notify the user of information which indicates the job of the fifth type but which does not indicate the job of the sixth type, before the shutdown process executing unit executes the process for turning off the power of the job processing apparatus.

40. The apparatus according to claim 32, wherein
the jobs of multiple types include a job of a seventh type which is being executed and a job of a eighth type which is not being executed, and
wherein in a case where the job of the seventh type and the job of the eighth type are stored in the storing unit when the accepting unit accepts the instruction for turning off the power of the job processing apparatus, the controller controls so as to cause the notifying unit to notify the user of information which indicates the job of the seventh type but which does not indicate the job of the eighth type, before the shutdown process executing unit executes the process for turning off the power of the job processing apparatus.
